(19) United States
(12) Patent Application Publication
(10) Pub. No.: US 2009/0081989 A1
(43) Pub. Date: Mar. 26, 2009

(54) SYSTEM AND METHOD FOR FINANCIAL TRANSACTION INTEROPERABILITY ACROSS MULTIPLE MOBILE NETWORKS

(76) Inventor: Christopher Andrew Wuhrer, Alexandria, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/237,830

(22) Filed: Sep. 25, 2008

Related U.S. Application Data
(60) Provisional application No. 60/974,919, filed on Sep. 25, 2007.

(51) Int. Cl. H04M 11/00

(52) U.S. Cl. 455/406

(57) ABSTRACT

A processor-readable medium stores code representing instructions to cause a processor to perform a process is described. The code includes code to receive from a first mobile device associated with a first network a minute transfer request. The minute transfer request is operative to transfer data associated with an allowable use time of the first mobile device from an account associated with the first mobile device associated with the first network to an account associated with a second mobile device associated with a second network different than the first network. The code includes code to send from the first network to the account associated with the second mobile device the data associated with the allowable use time based on the minute transfer request. The data associated with the allowable use time represents at least a portion of the allowable use time of the first mobile device.

### CROSS-REFERENCE TO RELATED APPLICATIONS

This application claims priority to U.S. Patent Application No. 60/974,919 entitled “System and Method for Financial Transaction Interoperability Across Multiple Mobile Networks” filed Sep. 25, 2007, which is incorporated herein by reference in its entirety.

### BACKGROUND

This invention generally relates to a system and method for funds transfer via a mobile device and more particularly to interoperability among mobile operator networks.

Currently, mobile device users cannot activate and deactivate financial payment tools, such as, for example, a credit card via a Java application on their mobile device. Additionally, mobile devices do not have an overdraft protection tool enabling the consumer to spend beyond the mobile service provider payment restrictions.

Prepaid mobile service providers have significant operating costs associated with prepaid cards and reloading the prepaid card with additional minutes. Prepaid mobile service providers and mobile application publishers are experiencing reload failures with respect to the mobile prepaid accounts and significant requests for gifting financial funds to an owner of a mobile prepaid account.

A cell phone owner belonging to a mobile service provider network cannot transfer minutes to another cell phone owner belonging to the same mobile service provider network. The cell phone owner cannot transfer minutes (i.e., talk time) or financial funds to another cell phone owner belonging to a different mobile service provider network via a cell phone using multiple account types.

Thus, a need exists for a system and method that solves the above-identified problems. Specifically, a need exists for a system and method that can activate and deactivate financial payment tools, enable overdraft protection, electronically obtain prepaid minutes and transfer funds and/or minutes to a cell phone user belonging to a different mobile service provider network.

### SUMMARY OF THE INVENTION

A system provides a platform and application layer that can function across an array of payment platforms or network types including debit, prepaid billing systems and banking services individually or in concert with one another, serving as a hub for transactions across disparate transaction processors and prepaid operator billing systems. The system includes a set of APIs that support reload, gifting and funds transfer activities across mobile operator networks.

In one embodiment, a system enables a user to perform prepaid account reload and funds gifting from within a third party Wireless Application Protocol (WAP) or Java/Brew application across disparate prepaid and postpaid mobile networks. In some embodiments, a user can gift funds directly into another prepaid account for both intra-carrier and inter-carrier funds transfer. Within the same operator network, users can gift funds from their prepaid account or other banking or credit account. Users across networks can originate funds from a stored value, checking or banking account. In some embodiments, a system enables a user to draw from a surplus spending account greater than the individual mobile operator's spending limits to pay for carrier services such as value added services. In some embodiments, mobile operators can send a mobile device an electronic stored value card (e.g., prepaid calling card, debit card, etc.).

In one embodiment, a processor-readable medium that stores code representing instructions to cause a processor to perform a process is described. The code includes code to receive from a first mobile device associated with a first network a minute transfer request. The minute transfer request is operative to transfer data associated with an allowable use time of the first mobile device from an account associated with the first mobile device associated with the first network to an account associated with a second mobile device associated with a second network different than the first network. The code includes code to send from the first network to the account associated with the second mobile device associated with the second network the data associated with the allowable use time based on the minute transfer request. The data associated with the allowable use time represents at least a portion of the allowable use time of the first mobile device.

In another embodiment, a processor-readable medium that stores code representing instructions to cause a processor to perform a process is described. The code includes code to receive from a mobile device associated with a first network a financial transfer request configured to transfer funds from an account associated with a user of the mobile device associated with a first financial institution to an account associated with a receiving party at a second financial institution. The receiving party is associated with a second network different than the first network. The code includes code to send data associated with the funds from the first network to the second network to the account of the receiving party based on the financial transfer request.

In yet another embodiment, a processor-readable medium that stores code representing instructions to cause a processor to perform a process is described. The code includes code to receive from a first mobile device associated with a first network an account activation request and a financial transfer request. The code includes code to transfer funds from an account at a financial institution associated with the account activation request to an account of a second mobile device associated with a second network different than the first network based on the financial transfer request when the account associated with the account activation request at the financial institution is activated based on the account activation request.

In still yet another embodiment, a processor-readable medium that stores code representing instruction to cause a processor to perform a process is described. The code includes code to send from a first mobile device associated with a first network a minute transfer request such that data associated with an allowable use time based on the minute transfer request is sent from an account associated with the first mobile device associated with the first network to an account associated with a second mobile device associated with a second network different than the first network. The code includes code to receive a confirmation after the data associated with the allowable use time is received at the account associated with the second mobile device.

In another embodiment, a processor-readable medium that stores code representing instruction to cause a processor to perform a process is described. The code includes code to send from a mobile device associated with a first network a financial transfer request such that data associated with funds based on the financial transfer request is sent from an account associated with a user of the mobile device associated with a first financial institution to an account associated with a receiving party at a second financial institution. The receiving party is associated with a second network different than the first network. The code includes code to receive a confirmation after the data associated with the funds is received at the account associated with the receiving party at the second financial institution.

### BRIEF DESCRIPTION OF THE DRAWINGS

FIG. 1 is a functional block diagram including a system, according to an embodiment of the invention.

FIG. 2 is a schematic diagram including a system, according to an embodiment of the invention.

FIG. 3 is a flow chart of possible funds transfer scenarios including a system, according to an embodiment of the invention.

FIG. 4 is a gifting and reload interoperability block diagram including a system, according to an embodiment of the invention.

FIG. 5 is a flow chart of a gifting module of a system, according to an embodiment of the invention.

FIG. 6 is a flow chart of a reload module of a system, according to an embodiment of the invention.

FIGS. 7-19 are examples of graphical user interfaces (GUIs) displayed during use of a system according to an embodiment of the invention.

### DETAILED DESCRIPTION

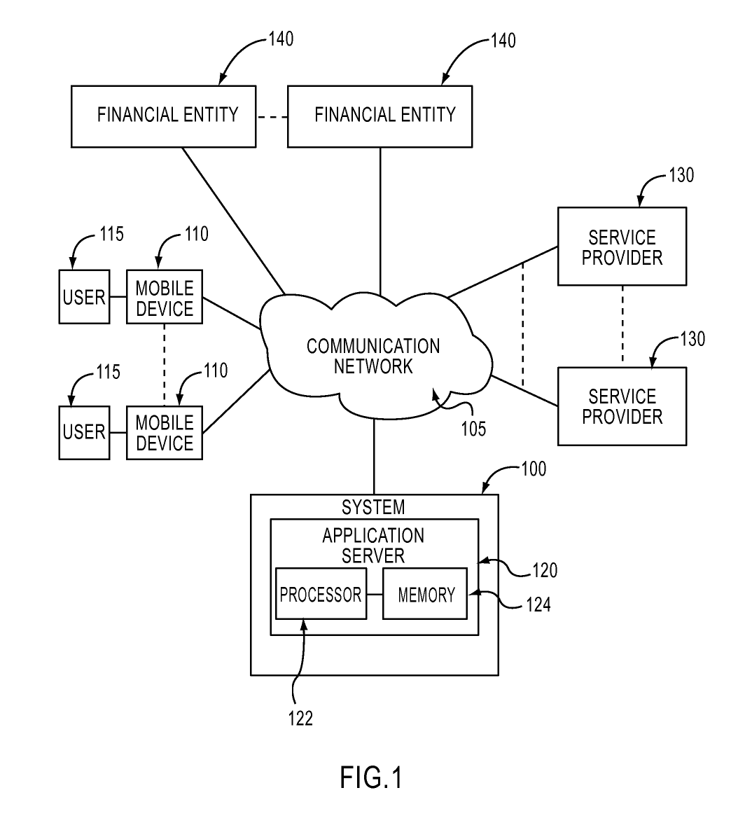

FIG. 1 is a functional block diagram including a system, according to an embodiment of the invention. The system includes an application server configured to facilitate intra and inter carrier funds brokering, global funds transfer and overdraft protection.

The systems and methods can be embodied in one or more hardware and/or software programs. The methods of the invention are described herein as being embodied in computer and mobile handset programs (software and/or hardware) having code to perform a variety of different functions. It should be understood, however, that the methods are not limited to an electronic medium and various functions can be alternatively practiced in a manual setting. All of the various methods described herein can upload and deliver financial data and interoperable data in a variety of different formats. For example, financial data can be in textual format, in tabular format, graphical format, diagrammatical format, or chart format. The financial data can be transmitted via a network connection and/or via email using the Internet.

The application server 120 according to an embodiment of the invention can be used to process data in accordance with the invention. Application server 120 includes a processor 122. The application server 120 can be in communication with one or more entities or devices (e.g., a financial entity, a mobile service provider, etc.) via a broadband connection, high-speed network or other data connection. The application server 120 can be in communication with one or more mobile devices (e.g., a cellular phone) via a cellular or other wireless network. The processor 122 can be, for example, a commercially available personal computer, or a less complex computing or processing device that is dedicated to performing one or more specific tasks. For example, the processor 122 can be a terminal dedicated to providing an interactive graphical user interface (GUI). A GUI can also include accessories to provide audio output in addition to the visual output. The processor 122, according to one or more embodiments of the invention, can be a commercially available microprocessor. Alternatively, the processor 122 can be an application-specific integrated circuit (ASIC) or a combination of ASICs, which are designed to achieve one or more specific functions, or enable one or more specific devices or applications. In yet another embodiment, the processor 122 can be an analog or digital circuit, or a combination of multiple circuits.

The processor 122 can include a memory 124. The memory 124 can include one or more types of memory. For example, the memory 124 can include a read only memory (ROM) component and a random access memory (RAM) component. The memory 124 can also include other types of memory that are suitable for storing data in a form retrievable by the processor 122. For example, electronically programmable read only memory (EPROM), erasable electronically programmable read only memory (EEPROM), flash memory, as well as other suitable forms of memory can be included within the memory 124. The processor 122 can also include a variety of other components, such as for example, co-processors, graphic processors, etc., depending upon the desired functionality of the code.

The processor 122 is in communication with the memory 124, and can store data in the memory 124 or retrieve data previously stored in the memory 124. In other words, the memory 124 can be a processor-readable medium storing code representing instructions to cause the processor 122 to perform a process. The code can be any interpretable or executable code mechanism, such as, for example, interpretable programs, dynamic link libraries (DLLs), Java classes and applets, complete executable programs, and the like.

The components of the processor 122 can communicate with devices external to the processor 122 by way of an input/output (I/O) component (not shown). According to one or more embodiments of the invention, the I/O component can include a variety of suitable communication interfaces. Additionally, the I/O component can include, for example, wireless connections, such as infrared ports, optical ports, Bluetooth® wireless ports, wireless LAN ports, or the like. The network to which the processor 122 is connected can be physically implemented on a wireless or wired network, on leased or dedicated lines, including a virtual private network (VPN).

The application server 120 can communicate with mobile devices 110 of users 115, financial entities 140 and service providers 130 via a communication network 105. The term a service provider can also be referred to as an operator, a mobile operator, a carrier, an access provider, a carrier merchant, or the like. The communication network can be, for example, a cellular network, a wireless network, the Internet, or the like.

The mobile device 110 can be used by a user 115 to interface with the system 100. Specifically, the user 115 can interface using the mobile device 110 across the communication network 105 for various purposes (i.e., to send data to and receive data from the application server 120). Throughout this specification, several references to the term a user is made for convenience. The term a user should be construed broadly. A user can be, for example, an actual person, a mobile device, a handset, a cell phone being used by a user, an entity, a mobile operator, etc. A person can be, for example, a cell phone owner, a subscriber of a mobile service provider, a business owner, an un-banked mobile subscriber, an under-banked mobile subscriber, a banked mobile subscriber, etc.

In one embodiment, the mobile device 110 can be any known communication device capable of producing a signal associated with input from the user 115 and messaging data associated with input from the user 115. The mobile device 110 is capable of transmitting data over a wireless network. The mobile device 110 can be, for example, a processor system including one or more processors, a server as described above, an IP enabled appliance/device, a computer, a workstation, a thin-client, a personal digital assistant (PDA), a mobile communication device, a cellular phone, or any other processor. The term mobile device can also be referred to as a handset. The messaging data can be produced by any known textual input device, such as, for example, a telephone keypad, a keyboard, or the like. The mobile device 110 can include a display configured to display GUIs and other windows to the user 115.

The mobile device 110 can include a system mobile application or platform (SMA). One function of the SMA is to facilitate domestic and global transactions to and from a user's 115 debit card, credit card, bank account or mobile prepaid account with complete control from the mobile device. The mobile device can transfer, send, and receive funds. The SMA transforms the mobile device 110 (e.g., wireless handset) into a banking terminal able to receive, send and transfer funds to friends, family members, and employees across all bank account types and any prepaid operator networks. With this functionality, the SMA can reduce obstacles associated with bill payment, peer-to-peer transactions and prepaid account reloading. The SMA can also be referred to as a system handset client, handset client, client, mobile client, or the like.

The application server 120 can include the SMA or component located in the memory 124. The SMA can be configured to interface with the mobile device 110 to produce instructional data as well as other data associated with the user 115. In one embodiment, the SMA is streamed from the application server 120 to the mobile device 110 via the communication network 105. Specifically, at least a portion of the SMA is continuously sent by the application server 120 and received by the mobile device 110. In some embodiments, the SMA is downloaded locally at the mobile device 110 from the application server 120 via the communication network 105. In some embodiments, at least a first portion of the SMA is streamed from the application server 120 to the mobile device 110 and at least a second portion of the SMA is downloaded locally at the mobile device 110.

The application server 120 can access financial data associated with the user 115 at a financial entity 140. The financial entity 140 can include a processor system, such as, for example, a server as described above, a computer, a thin-client, or the like. The financial data can be stored in a memory component of the processor system of the financial entity 140. Specifically, the application server 120 can access an account of the user 115 based on permission from the user 115. The financial entity 140 can be, for example, a bank, a credit card company, an insurance company, an investment company, etc. The account can be, for example, a savings account, a checking account, an asset management account, a money market fund, an investment account, etc.

The application server 120 can access mobile service accounts associated with the user 115 at the mobile service provider 130. The service provider 130 can include a processor system, such as, for example, a server as described above, a computer, a thin-client, etc. The mobile service account data can be stored in a memory component of the processor system of the service provider 130. The mobile service provider 130 can be, for example, a cellular phone service provider or the like. For example, the mobile service provider 130 can be Verizon Wireless, Cingular, AT&T, Nextel, Sprint, T-Mobile, etc.

The system 100 includes a peer-to-peer (P2P) domestic/international application, a gifting application, premium short messaging service (P-SMS) application for overdraft protection, a reload application and a bill pay application. The P2P application is configured to transfer financial funds between users across different mobile service providers based on input from the mobile device of one of the users from a Java application or a WAP application belonging to application publisher or belonging to the system 100. The gifting application is configured to transfer funds and/or minutes from a first user to a second user. The P-SMS application enables a post-paid user of a mobile service provider to send funds from an account to another user for the benefit prepaid users who have insufficient funds. The reload application can recharge prepaid accounts and stored value accounts, such as, for example, a college stored value account. The bill pay application enables a user to pay their bills using the mobile device.

The system 100 can include a data warehouse (e.g., a database) coupled to the application server 120. The database architecture is configured to store high-level data, such as, for example, transaction data, customer account information (e.g., prepaid, banking, credit card, debit card), customer application settings, system account information (e.g., virtual banking account where money is sent and stored until transferred to primary accounts) including the amount of funds, identification of the owner of the account, customer billpay calendar/schedules along with bill receipts, customer logon and account security information, reporting, etc. Reporting can be a unique database instance to capture and maintain data related to all transaction types and sources of transactions including distribution partner (e.g., Verizon, Sprint, Amazon, etc.).

The application server 120 can send signals to and receive signals from the mobile device 110 or another entity. Similarly, the mobile device 110 can send signals to and receive signals from the application server 120 or another entity. In some embodiments, the signals can include control signals including instructions pertinent to a particular transaction. For example, Java applications belonging to third party application providers can initiate reload and gifting transactions from within their own applications.

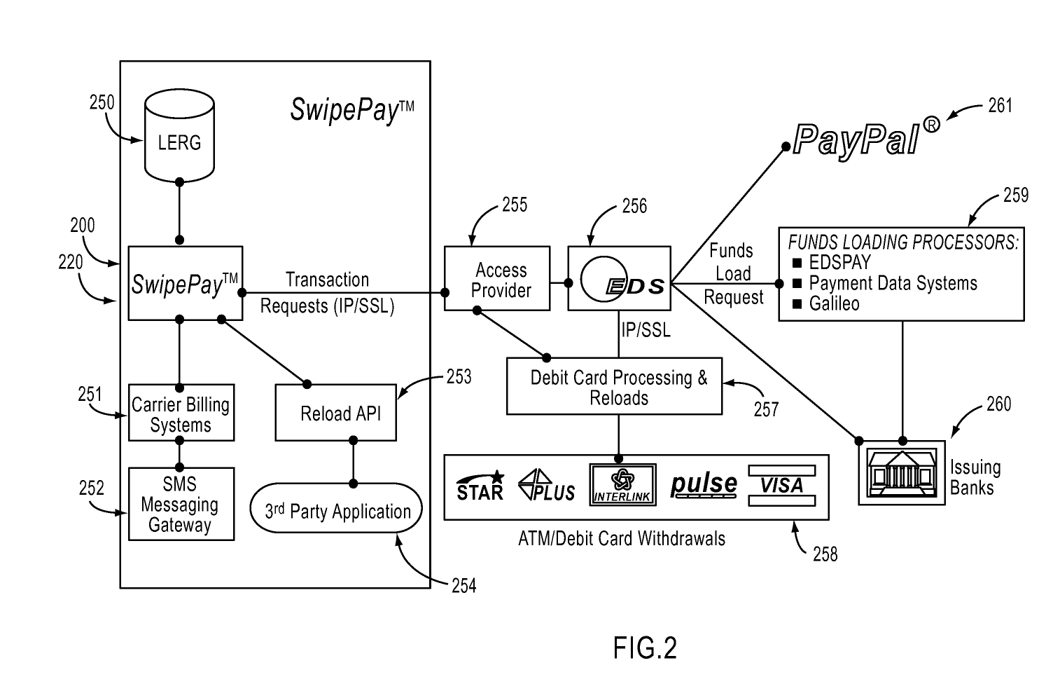

FIG. 2 is a block diagram including a system 200, according to an embodiment of the invention. The system 200 is coupled to a local exchange routing guide (LERG) 250, carrier billing systems 251, a reload application program interface (API) 253 and an access provider 255. The LERG 250 is configured to reconcile a mobile phone number to a specific mobile operator. The carrier billing systems 251 are each coupled to a short messaging system gateway (SMS) 252. The carrier billing systems 251 are each configured to produce an invoice associated with an mobile service provider account of the user. The SMS 252 is configured to send short messages to and receive short messages from a mobile device (not shown). The short messages can include financial information, account details, funds transaction data/instructions, etc. The reload API 253 is coupled to a third party application 254. The third party application can be, for example, a subscription-based service such as a dating service, digital television service, or the like.

The system 200 can output a transaction request to the access provider 255 using internet protocol (IP) and a secure socket layer (SSL). The access provider 255 is coupled to a backend payment processing system (e.g., EDS) 256 configured to facilitate communication between the access provider 255 and electronic payment tools and services, such as, for example, PayPal 261. For example, the backend payment processing system 256 can request a funds load to a funds loading processor 259 (e.g., EDSPAY, Payment Data Systems, Galileo) that is configured to transfer funds from or to an issuing bank 260 of the user. All funds not gifted to a prepaid account can be received in a system account provided to the user. The access provider 255 and EDS 256 are both coupled to a debit card processing and reloads server 257. The debit card processing and reloads server is coupled to debit card provider and automated teller machine (ATM) provider 258, such as, for example, Star, Plus, Interlink, Pulse, Visa, etc. The debit cards provided by the debit card providers enable the user to withdraw funds from a debit card account via the ATM.

The application server 220 of the system 200 can include a system mobile money management platform to enable anyone with a mobile device to send, receive and transact funds securely anywhere in the world. The application server 220 can support large and growing markets for funds transfer, unbanked money management and secure payments.

The system 200 includes multiple connections into a financial network provider, whom provides connectivity into a number of banking intuitions, debit card processors, and payment processing centers. The system 200 can also include individual connections into various types of prepaid carrier billing systems including but not limited to Amdocs, BCGI, and Convergys to support prepaid recharging and transfers from individual bank accounts. The network provider can provide connectivity into backend payment processing systems such as First Data and EDS.

The SMP can include functionality, such as, for example, provisioning and management, billing, reporting, receipt delivery and customer care interface. Provisioning and management enables wireless operators and service providers to create and manage services. The billing can be integrated into carrier billing systems to support prepaid top off, purchase of digital content and payment of prepaid account. Reporting enables the operator to guarantee certain service environment metrics (e.g., message throughput) to the service provider. Receipt delivery provides the network pathways for wireless applications to interact with the service environment. The customer care interface can include password reconciliation and transaction tracking.

The SMP can support a number of integration points with different types of content and application providers. The handset or mobile device can support Java 2 platform micro edition (J2ME), Brew, Windows CE, or the like. The handset can include any known wireless application protocol (WAP). Short message service (SMS) and simple mail transfer protocol (SMTP) integration into the carrier messaging infrastructure can support alert notification associated with payment receipt, payment request, bill notification, low funds, etc. The carrier messaging infrastructure can also support a Java application to send and receive such alerts. Carrier billing platforms, such as, for example, Amdocs, BCGI, Convergys and Qpass can be integrated.

The application server 220 is coupled to a communication network and can include multiple application connection types. The SMP can be designed for ubiquitous connectivity into the various types of carrier billing systems, financial systems (Trycera, EDS, Galileo, etc) and bill pay networks. Specifically, the platform can support a multitude of network connection types. The system 200 can provide a secure client to server connection utilizing one of several secure transfer protocols such as SSL, SSH, WSP, secure HTTP, AS2, AS3, over a secure VPN/VAN. The system 200 can utilize a data encryption process to support password encryption or public keys. The system 200 can connect (i.e., message delivery connectivity) SMP to carrier messaging infrastructure via one of several communication protocols including SMPP, SMTP, M7, UCP, TAP, SMNP, EAIF, and HTTP over a sure network connection such as VPN or SSL. The SMP can support various application programming interfaces (APIs), but emphasize the most common SMPP (Short Message Peer-to-Peer, v3.3, v3.4, and v3.5). The system 200 includes transport layers. In other words, the SMP can support XML, and or SOAP (MAPP) as the data translation layer. The SMP can connect into the financial network provider supporting the data transfer between the bill pay, banking, and debit card processors or the intermediary brokering the connectivity and meet the VISA CISP requirements. The system 200 can connect into prepaid billing systems of each mobile operators (e.g., carrier billing systems) to support the reloading of subscriber accounts. The carrier billing systems 251 can support the origination of funds from a debit card, system account, credit card or bank account and the direct transfer of funds to the carrier prepaid account. Specifically, the carrier billing systems only support the ability to add funds to or decrement funds from an account. A financial access provider manages the funds transfer.

The system 200 can communicate with handhelds (not shown) via multiple message types and can be optimized for each handset across all operators. The system 200 can support message alerts delivered to the handset application and as a text message delivered either through SMPP or SMTP. The system 200 can support the delivery of text alerts (i.e., message delivery) when the Java or Brew application is turned off and money has been received and pending delivery acceptance by an account user. The messages can include a personal telephone number (PTN) or alias from which funds were sent. If payment is due as a result of a product sold from a partner site, the item, commerce site, amount, terms and destination of funds transfer can be included in the body of the text message or message delivered to the handset client. The system 200 can route messages. Specifically, the system 200 enables users to originate messages from the handset client to be delivered to another system handset client or as a text message delivered as an SMS depending on the status of the handset (on/off). Users can use canned messages alerting another system subscriber that funds are needed. For example, the message can be “please send me $500. John. Account-John123) Send Funds >>.”

The system handset client can output available application features, such as, for example, new account registration, send domestic funds, send international funds, check balances, gift prepaid minutes, apply for debit card, set alerts, message center, customer care, etc. In some embodiments, the user can register for bill pay and have the funds deducted from a bank account, debit card or system account. Bill pay services can be billed by a per transaction basis. Funds are deducted in the beginning of each month. Signup is available from within a BillPay module. Users can first register as a system member. When an account has insufficient funds, all bill pay services are suspended and the user is notified. In some embodiments, the system 200 will retry, for example, 5-times over 5 days before cancelling service. The user can restore service when payment is rendered. The user can access reports that track all bills paid within a time period, such as, for example, the last 6 or 12 months. Reports can be exported to Excel format with the flexibility for the user to define the time period. In some embodiments, users can setup a calendar corresponding to specific dates that bills must be paid. Users can also create new bill payment accounts using payee name, account and routing information. All information can be setup via the Internet and available through the handset.

First time users register to use the system 200 as a first step prior to viewing the main menu. Fields that can be required to register include user name, password, secret question, email address (if available), mobile phone number, etc. Users will then be prompted to setup a bank account and prepaid account or register for their own prepaid debit card. Once registered, users will receive account information sent to their handset and email address. This registration information will also be used to populate the user name and password field on the debit card registration page in order to reduce the number of passwords needed. They system 200 can also support an alias that can be used instead of a phone number to maintain anonymity, such as, for example, abcd28. User names will have to be checked against the system database (not shown) to determine availability. Each new account is assigned a virtual bank account and the user can be asked, upon request, if they want a debit card. Following registration, users can be required to enter their 4-digit code to receive the main menu. Users logon using their PTN and a 4-digit numeric code offered by the user. Logon credentials can work from any handset and from the website. Upon subsequent logons, the user will be required to enter their 4-digit code. If users have not established at least one account type, users will continually be prompted until this is completed. All transactions, personal settings and reporting data can synchronize across the web and handset. All data is stored with the application server 220 and not locally on the handset. Users can be asked to setup bank, credit card and mobile prepaid accounts immediately after registering with the system 200 for the first time either from the handset or the web. Users can be requested to fill in appropriate banking information or debit card information. From the debit card fields, the user can request a new card. Once the user requests a new card, they can be delivered to a new card registration page (not shown).

The system 200 can transfer funds domestically. The system 200 can determine destination account alias or PTN. Accounts are accessed through a handsets contact list. Additional contacts can be added directly through the application. The user can select origination bank, credit, debit, or prepaid account and can set a default account. The user can enter amount of funds to be transferred. In some embodiments, a limit can be placed on the amount of funds able to be transferred per transaction. The system 200 can alter this amount as needed. The system 200 can determine if a destination account or debit card is valid. If no account exists, the handset outputs an appropriate error message and suggests sending funds via P2P method to the user. Upon initiating the funds transfer, users will receive a confirmation and a message receipt delivered to the Alerts area of the handset. Funds can be transferred directly to a dependent (e.g., child) debit card account without first being deposited into a system account if the dependent does not have a system account on record. Funds can be received by non-members of the system 200 when delivering funds to a valid debit card or from a prepaid account to another prepaid account on the same network.

The user can have the option to originate funds from a default account (e.g., banking, credit card, or debit card) or have the option of changing the account to another source of funds already setup by the user. The user can then enter in the destination account (either a PTN or system user account name). Users can then select the amount of the transfer. Once the user submits the information, the system 200 will authenticate the destination account, the amount sent against available funds, international or domestic, if sufficient funds are available to pay for the transfer, and that all transfer guidelines are met. Once the funds are transferred, the user can receive (e.g., via the handset) a notification that funds have been transferred successfully or if an error has occurred. Once the funds have been received by the destination account, the Sender will receive (e.g., via the handset) another notification that funds have been accepted. Notifications are stored in the users reporting and transaction history for a time period (e.g., 6 months) for the handset and also at the application server 220.

Users sending money to a destination address do not necessarily need to reveal their PTN. Usernames can also be used instead of a PTN. All system account holders will be able to use their alias which is established upon registration. All transactions and notifications are synchronized and stored on the web for access. Funds can be transferred to a debit card directly if a system account is not setup for this user. The sender can send the funds to the debit card number. For example, a dependent card holder resides in Mexico and does not have a cell phone or an account registered with the system 200. SMP will verify the existence of adequate funds before authorizing the account transfer. In the event of insufficient funds, the user can be notified (e.g., the handset outputs) of the issue and given the opportunity to reload and request funds.

The system 200 can transfer funds internationally using the same process described above. International funds transfer fees can apply when users are originating funds from a debit card. International funds withdrawal fees can apply when a debit card is used to withdraw cash via a debit card.

Funds can be received into the system account which is a virtual non-interest bearing account. Funds remain in this account until transferred to a debit card account, prepaid account or bank account. Funds can be received directly to a debit card if the user does not have a system account on record (e.g., dependent account).

Gifting includes sending funds directly to the user's mobile prepaid account. Users can gift funds to another prepaid subscriber by directly depositing funds into the carrier prepaid billing system. Users are not restricted to their own prepaid accounts, but rather a user of a first carrier can gift funds to a user of a second carrier different from the first carrier.

In some embodiments, when funds are requested from another system user, the mobile application supports one-click access to the send funds screen. In some embodiments, funds can be originated from any user account that is setup with the system account with the exception of sending cash from a prepaid carrier account. All other accounts including bank (e.g., checking and savings), credit card, debit card and the system account are eligible to originate funds. In some embodiments, the system 200 enables users to blacklist other system users by adding their PTN or system account ID from their handset to block the system users from sending messages to their handsets.

Alerts serve the purpose of notifying users that funds have been sent, received, or requested. Alerts also serve the purpose of notifying users that bills are due and an account contains insufficient funds. Alerts can be output by the handset and/or the application server 220. Bill notifications and insufficient funds notifications are customizable by the users by date, amount and account minimums. Users can receive a notification when funds are transferred. The notification can include fields, such as, for example, amount, date, destination, balance remaining of account used, account source (debit card, bank, etc), or the like. Users can receive a notification when funds are received and can include the fields described above. An icon is present on the main menu that alerts users that funds have been received and available in their system account. Users can respond by transferring funds to their bank account, prepaid account, or debit card. They can also use the funds to pay bills.

The user can receive a notification when funds are requested. Funds requests can also be automated when the system 200 is used in conjunction with a commerce site and when funds are due for the transfer of goods and services originating from a third party commerce application. The user can respond to the message or send funds to meet the request and can include fields, such as, for example, user ID requesting funds, amount, date, message, etc. The user's bill pay service can be supported by creating a calendar of providers that require recurring payments or as single debtors. Alerts can be created that signal the user that a bill is due. A link to send funds can be provided into the bill pay module. The bill pay notification can include fields, such as, for example, sender ID, amount, date, etc.

Notifications for insufficient funds can be customized by the user across any bank account, debit card or prepaid account. These account queries can be conducted at a time interval (e.g., every 6 hours) and after funds are both sent and received. The user can setup a second party to receive their alerts when balances on specific accounts meet a minimum threshold defined by the user. (e.g., prepaid account balance set by user at $5.00).

The system 200 can include a mobile debit application form that can be sent to the handset to be output to the user. Using the mobile debit application form, users can register for their own debit card as well as a dependent card. Once the card is received by the intended user, the user can activate the card via their handset. The user can then enter the card information in the account setup found within the system application. The card information can include fields, such as, for example, first name, last name, primary address, secondary address, city, state, country, ZIP code, home phone number, cell phone number, email address, etc. Activation of the card can include a call by the user from either their cell phone number or home phone number listed in the application. In some embodiments, primary account holders have the option of applying for a dependent card. This process can require the dependents name, mailing address and phone number. The option of applying for this card can be given to the user following the completion of their primary card holder application.

The system 200 enables a user to send minutes (e.g., gift) to a prepaid account of another user. The process for gifting is the same as gifting funds, which can require a destination account, amount, and all of the necessary validations required to verify that sufficient funds are available. Funds are deposited directly into the carrier account rather than the system account of the user. A method of gifting can include first having a user select gift prepaid funds (i.e., the handset receives an input associated with a selection of gift prepaid funds). Second, the user selects a destination account, such as, for example, a username or PTN. Said differently, the handset receives an input associated with the destination account from the user. Third, the user selects amount to be sent (i.e., the handset receives an input associated with an amount to be sent from the user). Fourth, the user confirms amount and destination (i.e., the handset receives an input associated with a confirmation of the amount and destination from the user). Fifth, the user selects submit (i.e., the handset sends gifting data to the application server 220). Sixth, the application server 220 determines if the account is valid. Seventh, the application server 220 determines if sufficient funds are available. Eighth, the application server 220 sends funds to an operator account. Ninth, the application server 220 sends confirmation to the sender (i.e., via the handset) with an adjusted balance. Tenth, the application server 220 sends an alert to the receiver with amount and current balance in prepaid. Eleventh, the funds are deducted from sender.

Throughout this specification, several references to a user receiving (e.g., a receiver) information, funds, minutes, etc. is made for convenience. It should be understood that a receiver's mobile device is receiving a signal from an entity, such as, for example, an application server. Similarly, several references to a user sending (e.g., a sender) information, funds, minutes, etc. is made for convenience. It should be understood that a sender's mobile device is sending a signal to an entity. Additionally, several references to a user performing an action, such as, for example, selecting a gift amount is made. It should be understood that when a user performs an action, this action is performed using, for example, a mobile device (i.e., a mobile device is receiving an input from the user).

In some embodiments, a reload locations menu item is used to assist system account holders in locating reload centers. By using ZIP code, debit card users can receive a list of reload centers closest to their location from a database coupled to the application server 220. This database can be continually updated as new reload centers become available.

To sufficiently manage the complexities associated with billing and settlement, the system 200 includes a content billing module. This module can manage partner additions, revenue settlement, and account reconciliation. The module can identify and manage revenue generated across dozens of concurrent applications available on operators and distribution partners with the ability to generate detailed usage reports and analysis. External reports provided to each partner can also include performance data that shares a complete view of all user transactions and transaction types. The content billing module can manage multiple billing channels. The content billing module can integrate into prepaid platforms, post-paid billing systems, and external credit and debit networks and offer the ability to authorize transactions in real-time. The content billing module API can support integration into carrier billing system over extensible markup language (XML) and/or hypertext transfer protocol secure (HTTPS) transmission. The platform can accommodate for large periodic bursts of transactions and real-time purchase authorizations.

The content billing module can include billing and settlement content aggregation. In other words, the module can support settlement for mobile operators and distribution partners. The system 200 can enable an administrator of the system 200 to define business terms and reconcile monthly billings against each mobile operator partner each week, month and/or quarter. For example, a report of Verizon can include, but is not limited to, percentages of different types of transactions. Following the example, Verizon can have a report stating: sent transactions: 20%, received transactions: 20%, debit card transactions: 20%, ATM withdraws: 20%, international transactions: 10%, international debit card withdraws: 10%. The SMP billing module can integrate into various billing systems to generate monthly, daily and weekly settlement reports to support accounting and tracking for various agencies. All data can be stored for the lifetime of the account and for a predetermined time period (e.g., 5 years) after the account is closed. The transactional data can be expressed in units.

In some embodiments, the content billing module can include third party billing, statement cycles, settlement process and website billing support. The module can facilitate the billing of premium content on third party content sites that have content distribution agreements with each operator supported through credit card, bank account and billing statements transactions. The module can include configurable partner account statement cycles that allow payables statements to be generated monthly and/or quarterly. The module can be configured to include billing period, partner, revenue share type by transaction (e.g., P2P, ATM, etc.), revenue share amount, refunds and net revenue. In some embodiments, the statement cycle is also managed through an IP Billing Platform. The settlement process can define account payable cycles for content partners on a recurring and definable weekly, monthly or quarterly basis.

The SMP reporting feature can provide multiple tiers of reporting to support the disparate information needs of the operator, service provider, customer service and accounting/finance functions. Vendor reporting can include web-based billing statements and activity reports for each partner account.

Carrier reports with the exception of statistical reports can include reporting data elements, such as, for example, carrier standard reports, carrier financial reports, carrier customer operations reports, carrier statistical reports, data sorting, file formats, error reports, etc. Carrier standard reports can include, for example, vendor name, number of individual subscribers, application, dates, number of transactions, type of transaction, number of error messages, type of error, gross revenue, net revenue, revenue share type, etc. Graphs can show message spikes and traffic patterns over a day, week, and/or month. Carrier financial reports can include, for example, revenue by service provider, revenue by application, total revenue by service provider, and/or revenue by time period as defined by user (default can be current billing cycle, revenue sorted by billing type including statement and credit card). Carrier customer operations reports can be accessible by user (e.g., subscriber) PTN. Fields of the report can include, for example, subscriber PTN, application provider name, application name, date of charge, charge amount, errors, etc. Carrier statistical reports can include, for example, average number of transactions per subscriber, average revenue generated by service provider and subscriber, average revenue generated by area code of calling area, growth rate of transactions over a definable time period in aggregate by Service Provider. Data sorting can sort by, for example, PTN, system account, NPX, time of day, day of week, revenue volumes, transaction volumes, transaction types, etc. File Formats can include, for example, hypertext markup language (HTML), Excel, tab delimited. Error reports can include, for example, payment errors, billing records received, processed and failed by operator or ecommerce partner, banking institution, etc.

The SMP reporting feature can include partner billing reports. The fields of the report can include, for example, mobile operator, application type (handset driven), total transactions, number (e.g., amount and/or number of transactions) of funds sent internationally and/or domestic, number of funds received, total number of reloads from application, source of funds (number of transactions from account type), average amount gifted, number of errors by type, net revenue shared, average reload amount, comparison reports by day, week and month, exportable into excel and tab delineated, number of unique Subs and gross ads by time period. An external extranet enables carrier access and definable reports by date range.

The SMP reporting feature can include internal billing reports. Internal billing reports are reports across each mobile operator and partner and total across all partners. The report can include fields, such as, for example, number of transactions, application type (handset driven), number of funds sent internationally and/or domestically, number of funds received, total number of reloads from application, source of funds (number transactions from account type), number of minutes gifted, number of errors by type, net revenue shared, application by region of US and country, red alerts (e.g., excessive transaction amounts including PTN and destination PTNS/region), reports generated by definable date range, comparison reports by carrier, partner by day, week, month, exportable into excel and tab delineated, number of unique Subs and gross ads by time period, number of inactive accounts by month, average reload amount, etc.

The SMP reporting feature can include suspicious activity reports. Specifically, the system 200 includes a real-time reporting engine that reports suspicious activity by carrier and account owner. Each alert can be defined by a system administrator (not shown).

The system handset client includes messaging and customization features. The system handset client enables users to blacklist other system users by adding their PTN or system ID from their handset blocking users from sending messages to their handsets as stated above. All messages originating from a transaction can be stored at a memory of the application server 220 and delivered to the handset upon user sign-on. For funds transfer application subscription renewals or from a user requesting funds, these message alerts will always be delivered to both an SMS inbox as well as a message notification module in the mobile client. Upon sign-on to the client, users will be alerted immediately that they have messages in their inbox for response. In addition, an icon in the client toolbar should be activated (i.e., bold or flashing) until all messages are read. The system 200 and/or the system handset client can edit messages based on their content, such as identified words and a variety of known anti-spam algorithms. The messages can be edited based on a third party anti-spam systems integrated into the system 200. The system handset client includes message controls. Specifically, the system handset client can control the number of outbound messages from a specific handset and to determine when excess messages occur from an account to other users.

The system 200 includes an account provisioning module and a central provisioning interface, such as, for example, a central web-based administrative console graphical user interface (GUI) that facilitates the provisioning and management of new operators/partners and existing business agreements accessible by SMP administrators. The role of the account provisioning module within the SMP is to facilitate the rapid provisioning of new mobile operators and publishers. The purpose of this toolset is to rapidly provision new partners, streamline new partner launch efforts and to facilitate complete end to end application testing. Administrators can also create general business rules covering revenue share, feature set selection, network alerts and performance indicators. The system 200 can track applications. Specifically, each new application can have a unique address and identifier in order to track and monetize each application. Carrier administrator can establish system and reporting access and grant privileges to individual account holders. Service Provider Administrator (i.e., partner administrative rights) can establish system access privileges to individual account holders, which allows various degrees of controls to view reports.

The system 200 can include a customer care module. The customer care module can include a web based interface to access customer records accessible by customer name, or PTN. Records can include transactions by type, partner, amounts, destination accounts, number of transaction per day, month and week. The customer care module enables a user to view all transaction attempts failed and successful. The Customer Care module can also provide customer assistance contacts for each application and content provider. The customer care module can reissue chargebacks to subscribers as either a credit to their billing statement or credit card (e.g., Visa, Amex, MasterCard, Discovery) or as a reverse charge to the debit account or bank accounts. Refunds, if provided, can be accrued each billing period and reconciled against each partner's monthly settlement.

The system 200 has a network architecture. Hardware deployed can be based on the requirements of operators, banking partners, backend provider and internal needs. Modular hardware architecture (servers and network elements) can scale arbitrarily depending on traffic needs. The platform can employ a flexible broker and router architecture easily scaled by adding middleware and deploying multi-machine environments. The network architecture can have a transaction throughput, such as, for example, 100 transactions per second and burst capabilities to additional transactions messages per second. Redundancy covering many areas of the platform, including external network (e.g., multi-line, multi-node access and VPN backup connection), the ability to append standby redundant hardware for internal network as well as redundant database and backup. Automatic failover mechanisms can be available to prevent complete system inoperability. The mechanism need not require a manual intervention or disrupt current system configurations or network connections. Alerts can be generated immediately following failover and failover correction. Each system module (e.g., provisioning, billing, reporting, routing, etc.) can be built on a distributed open architecture, facilitating multi-level integration based on multiple standards, such as, for example, common object request broker architecture (CORBA), .Net, Web Services and Java to enterprise edition (J2EE) or others.

The SMP system can support a number of authentication mechanisms depending on the connection protocol used between the client application and the server. To authenticate a service provider, the system 200 can employ SSL supported protocols and automated system authentication between the service provider and the SMP based on the configured account name and password. The system 200 can authenticate a user via a username and multiple digit code provided by the user. The system 200 can also validate the PTN of the user. The web interface of the system 200 can include a username and multiple digit pin to authenticate the user. Users can be granted a system email address. The SMP system can verify the existence of adequate funds before authorizing the account transfer. In the event of insufficient funds, the user will be notified of the issue and given the opportunity to reload and request funds. The SMP system can determine whether the destination of the user has a valid system account, prepaid account or debit card account before funds are issued.

The system 200 can include an application testing module. The role of the Testing Module within the CMP is to facilitate the rapid testing and implementation of new applications and partnerships across a wide range of supported handsets. An objective of the module can be to assist in streamlining the question and answer process for testing messaging applications and to create a uniform and efficient testing process that is repeatable across new applications. In some embodiments, a development channel within the platform can simulate network connectivity and a live testing environment. The “channel” can be conducive to testing network faults, application integrity, application and network latency, load testing, burst mobile originated messages (MO) traffic to stress test applications, etc. The application test reporting of the various testing scenarios can be communicated to the application provider in either an HTML results page or available report. Billing testing can also be provided using a common dummy account via each operator requiring connectivity. This will allow the service provider to test each application against the credit card and statement account billing methods. The testing scenarios can include, for example, network connection, application connection, message receipt at the application layer, message confirmation from the application, delivery of message to the various handsets, billing receipt, authorization and transaction. In some embodiments, the system 200 includes application support to support OTA upgrades and changes to menu structures, functionality and menu items.

The system 200 includes the system website (i.e., system mobile consumer website) that can provide subscribers the full set of features and services found on the system mobile application. As such, the system user can register a new account, setup and manage banking and debit accounts, send funds domestically and internationally, subscribe to billpay services, and gift minutes. The system website can include features, such as, for example, register, send domestic funds, send international funds, check balances, gift prepaid minutes, apply for debit card, set alerts, message center, bill pay, etc. Users can access reports that track all bills paid within a time period (e.g., the last 12-months). Users can export reports to excel for definable time periods. The system website can enable users to setup a calendar corresponding to specific dates that bills must be paid. Users can create new bill payment accounts using payee name, account and routing information. All information on the system website is accessible from the handset. The system website can include customer care features, such as, for example, email a care representative, lost password retrieval, close account, etc. The system website enables a user to manage accounts. The user can setup new bank accounts, debit card accounts and prepaid accounts. The user can edit accounts including delete existing accounts, change account numbers, change prepaid account number, add accounts, etc. The user can track all funds sent and received within a time period (e.g., the last 12-months). Users can send and receive funds via the system website by using their system account ID. The system website enables users to query the balance of any one of their banking, prepaid or debit card accounts. Account balances are also returned to the user in the messages module when transactions are completed.

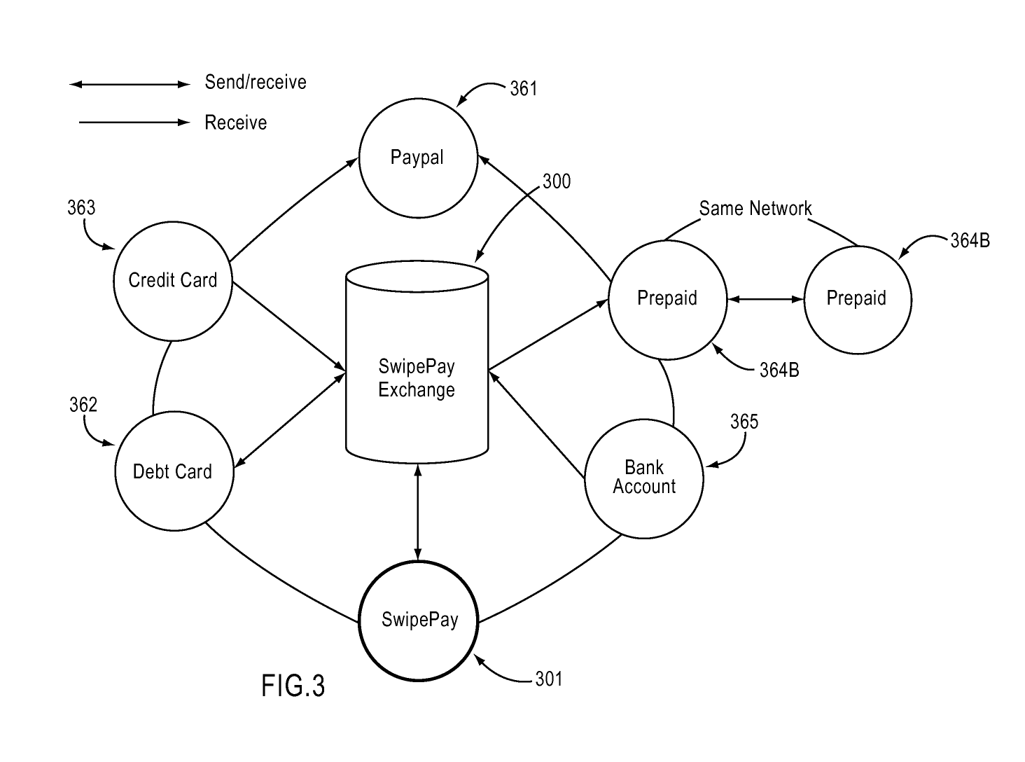

FIG. 3 is a flow chart of possible funds transfer scenarios including a system 300, according to an embodiment of the invention. The system 300 is configured to enable a mobile device (not shown) to execute transactions via the system 300. In some embodiments, transactions originate from a third party application through system platform APIs for the reload application and the gifting application. The system 300 is coupled to multiple accounts of the user, including for example, a system account 301, a debit card account 362, a credit card account 363, a PayPal account 361, multiple prepaid accounts 364 and a bank account 365.

The system 300 enables each of the possible funds transfers between the accounts based on input from the mobile device of a user. The double sided and single sided arrows define each account by how funds can unilaterally or bilaterally flow between other accounts. For example, the credit card account 362 can only originate funds while the debit card account 363 can both originate and receive funds. In other words, the system 300 can receive funds from the credit card account 362 whereas the system 300 can send funds to and receive funds from the debit card account 363.

The system account 301 of the user serves as the account default where it can receive funds and distribute funds to other account types. For example, in serving as the default account, all funds that are addressed to the user's alias or private telephone number (PTN) flow into the system account 301 before being transferred to another account type at a later point. Said differently, the system 300 receives funds from a first account before distributing the funds to a second account. In the case of a prepaid account 364, funds can only originate from the prepaid account 364A when the funds are being transferred to another prepaid account 364B on the same prepaid network. The prepaid accounts 364, can however, receive funds from any account despite a carrier network, such as, for example, the credit card account 363, a stored value account (not shown), or the bank account 365. In other words, the system 300 is configured to send funds to the prepaid account 364 of the user and to receive funds from the bank account 365 of the user. Secure payment tools, such as, for example, PayPal 361 can be used to transfer funds to the system account 301, which can then be used to distribute funds to the prepaid accounts 364 or another system account (not shown). The system 300 is also configured to send and receive funds from the system account 301 of the user.

The system 300 can enable funds transfer to the prepaid account 364. All funds can be received in the system account 301 if the user is registered with the system 300 and when the transfer is addressed to a system 300 username or PTN. Funds can be delivered to the debit card account 362, the prepaid account 364 or PayPal 361 account holder and not be a registered the system account 301 holder. Specifically, the system account 301 associated with the system 300 receives funds from a first account. The system 300 can then send funds from the system account 301 to a second account. For example, funds are received and sent by the system 300 when a user of a mobile service provider sends funds the prepaid account 364A to the prepaid account 364B of another user of the same mobile service provider.

The system 300 can enable funds transfer interoperability between accounts. Said differently, the system 300 enables funds transfer between a user of a first mobile service provider and a user of a second mobile service provider different from the first mobile service provider. Specifically, the system 300 enables interoperability across both prepaid and postpaid operators to reload and gift funds into prepaid mobile accounts. In other words, the system 300 enables mobile bucket to mobile bucket or stored value to mobile bucket gifting. More specifically, the system 300 can transfer funds from a prepaid account to another prepaid account, from a postpaid account to a prepaid account, from a prepaid or postpaid account to a third party, etc. A prepaid account can be, for example, a debit card, bank account, etc. A postpaid account can be, for example, a credit card or the like. In some embodiments, the sending account and the receiving account are on the same operator or network. In other embodiments, the sending account and the receiving account are on different operators or networks. For example, the user of the first mobile service provider can send funds from their debit card account 362 to the prepaid account 364 of the user of the second mobile service provider. The user of the first mobile service provider can, for example, send from their credit card account 363 to the prepaid account 364 of the user of the second mobile service provider. For example, the user of the first mobile service provider can send funds from the system account 301 to the prepaid account 364 of the user of the second mobile service provider. The user of the first mobile service provider can, for example, transfer funds from the bank account 365 to the prepaid account of the user of the second mobile service provider. As stated above, the system 300 receives funds into and sends funds from the system account 301 in each of the funds transfers.

The system 300 can transfer funds to the system account 301 where the receiver of the funds is a system account holder (not shown) and is registered with the system 300. The system account holder can register with the system 300 via the Internet, a Java or WAP application, etc. Specifically, the system 300 receives funds from one or more accounts. The user can send funds from, for example, a system account (not shown) to the registered system account 301 where the funds are deposited into the system account 301, the credit card account 363 to the system account 301, the debit card account 362 to the system account 301, the bank account 365 to the system account 301. In some embodiments, a user of a first account sends funds to a user of the system account 301. The first account can be, for example, a system account different from the system account 301, the credit card account 363, the debit card account 362, the bank account 365, or the like.

The system 300 can send funds from a debit card where the debit card holder is a member of the system 300. For example, a user can send funds from the debit card account 362 to another debit card account on the same debit card network. If the user transmits funds to an alias or PTN on another system account of a member of the system 300, the funds are delivered to the system account 301. If funds are sent to a PTN and the user is not registered with the system 300, both the user who sent the funds (i.e., the sender) and the intended user to receive the funds (i.e., a receiver) will receive a message of the failed transaction output by the system 300. The intended receiver of the funds will also receive a link to download the application and register with the system 300 output by the system 300. A user can send funds from the debit card account 362 to an account, such as, for example, a checking account, a money market account, a savings account, etc. A user can also transfer funds, for example, from a system account to the PayPal account 361. Specifically, the system account 301 associated with the system receives the funds. The system 300 then sends the funds from the system account 301 to the PayPal account 361.

The system 300 can transfer funds internationally. In other words, the system 300 can transfer funds from an account in one country to an account in another country. In some embodiments, funds transfer originating and sent to countries within the European Union are not considered international and all domestic tariffs would apply. All funds are received within the system account 301 of the receiver if the destination address is the users PTN or a system member username. Funds can be sent directly to another debit card account if the account number is used and the recipient is not a member of the system 300. The system 300 can send funds from, for example, the member debit card account 362 to another member debit card account, the member debit card account 362 to a non-member debit card account, the system account 301 to the member debit card account 362, the system account 301 to the non-member debit card account, etc. The system 300 can send funds from the bank account 365 to, for example, the member debit card account 362, the non-member debit card account and the system account 301. For example, the system 300 can send funds from the member system account 301 to a registered member system account where the funds are deposited into the registered member system account. The system 300 can send funds from the credit card account to, for example, the system account 301, the debit card account 362 with no recipient account registered, etc. The system 300 can send funds from the debit card account 362 to, for example, the system account 301, a debit card account with no recipient account registered, to a debit card account via a checking account, money market account, savings account, etc. The system 300 can transfer funds from any type of account to the PayPal account 361. For example, a user can transfer funds from to the PayPal account 361 from the member system account 301.

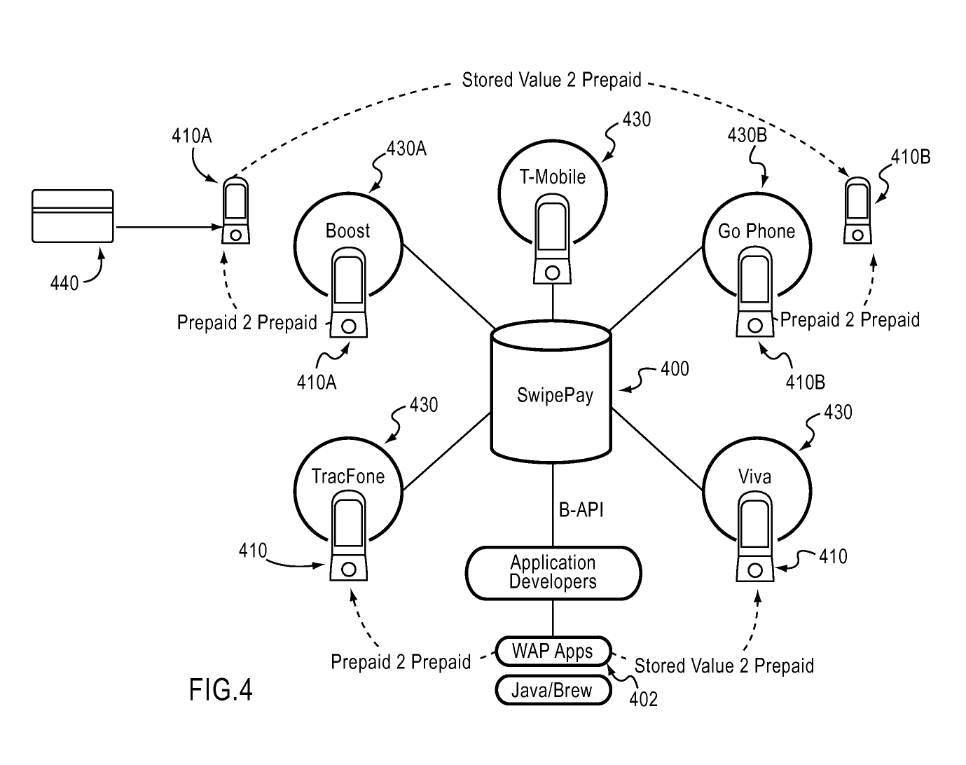

FIG. 4 is a gifting and reload block diagram including a system, according to an embodiment of the invention. The system 400 is coupled to multiple carriers 430, such as, for example, Boost, T-Mobile, Go Phone, TracFone, Viva, etc. Each carrier supports multiple mobile devices 410. The system 400 includes a gifting application and a mobile service interoperability (reload) application. Each of the mobile devices 410 can receive signals from and transmit signals to a financial institution 440.

The gifting application enables funds and/or cellular minutes gifting within the carrier network (e.g., between two mobile devices 410 who have the same carrier 430) and across other carriers 430 (e.g., between one mobile device with a first carrier and another mobile device with a second carrier different from the first carrier) from a handset application or from a third party application. The reload application enables the user to recharge prepaid accounts from within third party applications, such as, for example, a subscription community application, etc. The user can also recharge prepaid accounts from the Java/Brew application across networks and from multiple account types. The reload application can support PIN activation from carrier prepaid cards.

An integration of a system API and WAP extension enables the user to reload their own accounts when funds have been depleted or to gift funds to another mobile user using the same application. Funds can be transferred and gifted from a mobile device 410A associated with a prepaid account on a prepaid mobile operator to another mobile device associated with another prepaid account on the same prepaid operator even though neither the sender or the recipient is registered with the system 400. Gifting and debit card funds transfer recipients do not require system registration. Funds that originate from a stored value account, credit card or bank account from a financial institution 440 can be transferred and gifted across disparate carrier networks to prepaid accounts. For example, a mobile device 410A associated with carrier 430A can send or gift funds/minutes from a stored value account to a prepaid account of a mobile device 410B associated with carrier 430B.

The system 400 enables credit card holders and bank account holders to register with the system 400 to support reloads and gifting. The sender can register with the system 400 to originate funds from any account other than a prepaid account. The system 400 can utilize existing debit card systems with a WAP registration process for new card applicant. The system 400 provides the APIs and meta-data to each publisher in order to facilitate the signup procedure and funds transfer. The carriers 430 (e.g., mobile operators) can receive a percent of each reload and gifting transaction.

The gifting and reload applications can be performed from within a third party subscription Java/Brew, WAP application 402, premium short messaging service (P-SMS) and digital storefronts. For example, a user can from the WAP application send or gift funds/minutes from a stored value account to a prepaid account of a mobile device 410. The system includes a P-SMS application designed for users and messaging aggregators as an overdraft tool when their purchases of services exceed the carrier imposed spending limit. For example, if the user were to purchase a dating or social-networking service, and as a result, exceeded the maximum limit that the carrier has allowed, the service vendor, can deliver a WAP link that allows the user to register for the system and add a stored value account, credit account or bank account. The system serves as an overdraft protection tool enabling the user to spend beyond the carrier payment restrictions. The user also has the ability to request a gift from another mobile user, if that user is registered with the system. For example, a first user can request a gift from a registered second user when the first user exceeds the mobile account limit.

In some embodiments, a first time user originating from a third party WAP and Java application loads funds using a stored value account. The user subscription renewal fails and user wants to add funds. The user must register with the system and enter account information that either includes a debit card, credit card or bank account (at least one account is required). If the user is unbanked (i.e., does not have a bank account) and without a credit card, the user will be directed to WAP page that contains the necessary fields to request a debit card.

In some embodiments, a first time user originating from a third party WAP and Java application gifts on the same operator network. The user receives a request to gift funds from another user or initiates a gift themselves. If the user is on the same operator network and would like to gift funds from their own prepaid account, registration is not required. It is helpful for the giftor to know the carrier of the giftee. If this information is not collected, the system must perform a query to validate the destination carrier and that the carrier is active with the system.

In some embodiments, a first time user originating from a third party WAP and Java application gifts on the same operator network using a stored value account. If the giftor operator is not the same as the giftee operator, then the giftor sends funds from a stored value account. In this case, the giftor is required to register with the system and add a valid stored value account, credit account or bank account. In some embodiments, the giftee does not have to be registered with the system unless they want to maintain an alias rather than disclosing their PTN. The giftor can only register one account when sending funds from within the third party WAP or Java application. Once the giftor initiates the transaction, the system validates the account and that sufficient funds are available. Assuming sufficient funds are available in the account, the giftor and the giftee receive notification of the transaction.

In some embodiments, an existing time user originating from a third party WAP and Java application reloads from a stored value account. User subscription renewal can fail and the user is prompted to reload funds. The reload prompt is managed by the publisher. The user can reload from an existing stored value account or request a gift from a friend. If reloading from a stored value account on record with the system, the user must enter a valid username and password. This information is collected via the system API and validated against the user's account. If sufficient funds exist in the stored value account, a confirmation is sent to the user.

In some embodiments, an existing user originating from a third party WAP and Java application is sending a gift to another user on another carrier using a stored value account. The user would enter the destination address of the giftee and the funds would be withdrawn from the default account type of file with the system.

In some embodiments, a user originating from a third party WAP and Java application can update account information in the system. The user can access a link from within the third party application or the system website to access their account information from the system. The user also has the option to download the system application from either their carrier storefront or a system download center available on WAP.

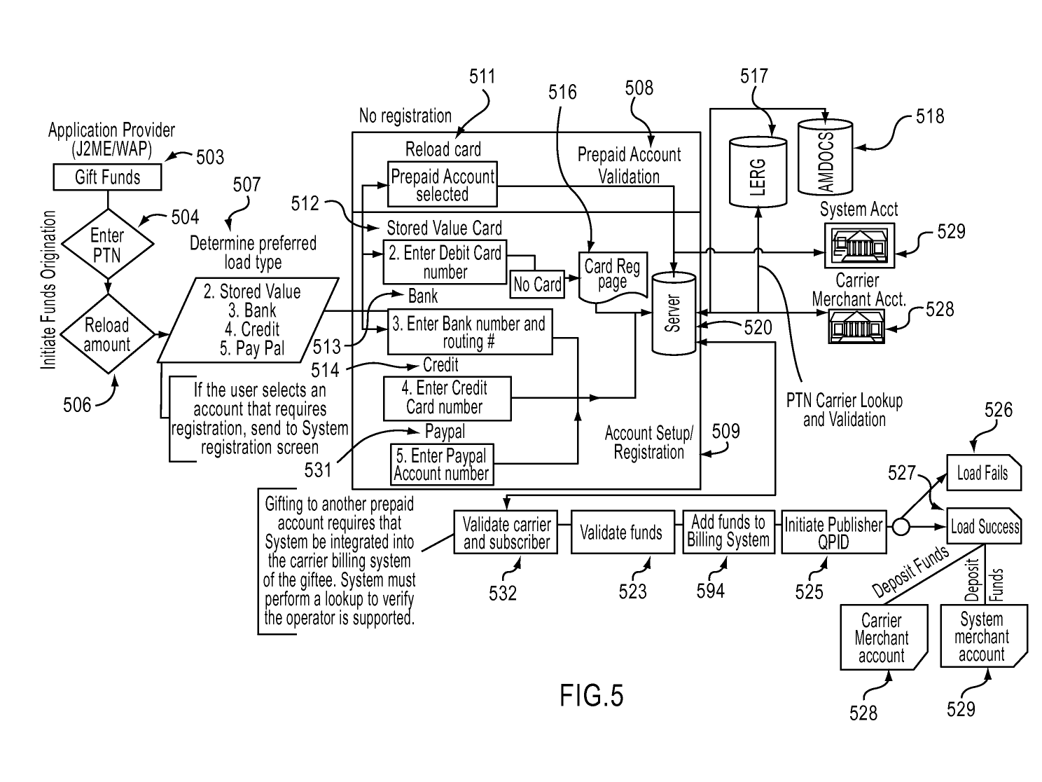

FIG. 5 is a flow chart of a gifting application including a system, according to an embodiment of the invention. Once a mobile device receives input associated with gifting funds 503, the mobile device prompts the user to enter a receiving PTN 504, a reload amount 506 and a determined preferred load type 507, such as, for example, a reload card, a stored value account, a bank account, a credit account, a PayPal account, etc. If the user selects an account that requires registration, the mobile device can output a system registration screen.

If registration is not needed, the mobile device outputs a graphical user interface (GUI) based on the selected determined preferred load type 507. The mobile device can output a reload card 511, a stored value card 512, a bank interface 513, a credit interface 514 or a PayPal interface 531 based on the determined preferred load type 507. The reload card 511 is output if a prepaid account is selected and sends a signal to an application server 520 for prepaid account validation 508.

The mobile device outputs an interface associated with account setup and registration 509, such as, for example, the stored value card 512, the bank interface 513, the credit interface 514 or the PayPal interface 531. The mobile device outputs the stored value card 512 to the user and prompts the user to enter a debit card number when the stored value is selected as the determined preferred load type 507. The mobile device sends a signal associated with the debit card number to the application server 520. If no card number is entered at the mobile device, the mobile device outputs a card registration page 516 to enable a user to obtain a debit card. Once the debit card is obtained, the mobile device sends a signal associated with at least the debit card number to the application server 520.

The mobile device outputs the bank interface 513 to the user and prompts the user to enter a bank number and a routing number when the bank account is selected as the determined preferred load type 507. The mobile device sends a signal associated with at least the bank account to the application server 520. Similarly, the mobile device outputs the credit interface 514 to the user and prompts the user to enter a credit card number. The mobile device sends a signal associated with at least the credit account to the application server 520. Similarly, the mobile device outputs the PayPal interface 531 to the user and prompts the user to enter a PayPal account number. The mobile device sends a signal associated with at least the PayPal account to the application server 520.

Once a signal is received by the application server 520, the application server 520 can validate the carrier and subscription of the user 532. Gifting to another prepaid account requires that the system 520 be integrated into the carrier billing system of the giftee. The system must perform a lookup to verify the operator is supported. The application server 520 looks up the PTN carrier for validation in the local exchange routing guide (LERG) 517. The application server 520 adds funds to the billing system 594 if the application server 520 validates that there are sufficient funds 523 in the account via a billing system software, such as, for example, AMDOCS 518, etc. The application server 520 initiates publisher QPID 525, the billing transaction to renew the subscription for the publisher. The load can fail 526 or be successful 527. If the load is successful 527, funds are deposited into a carrier merchant account 528 or a system merchant account 529.

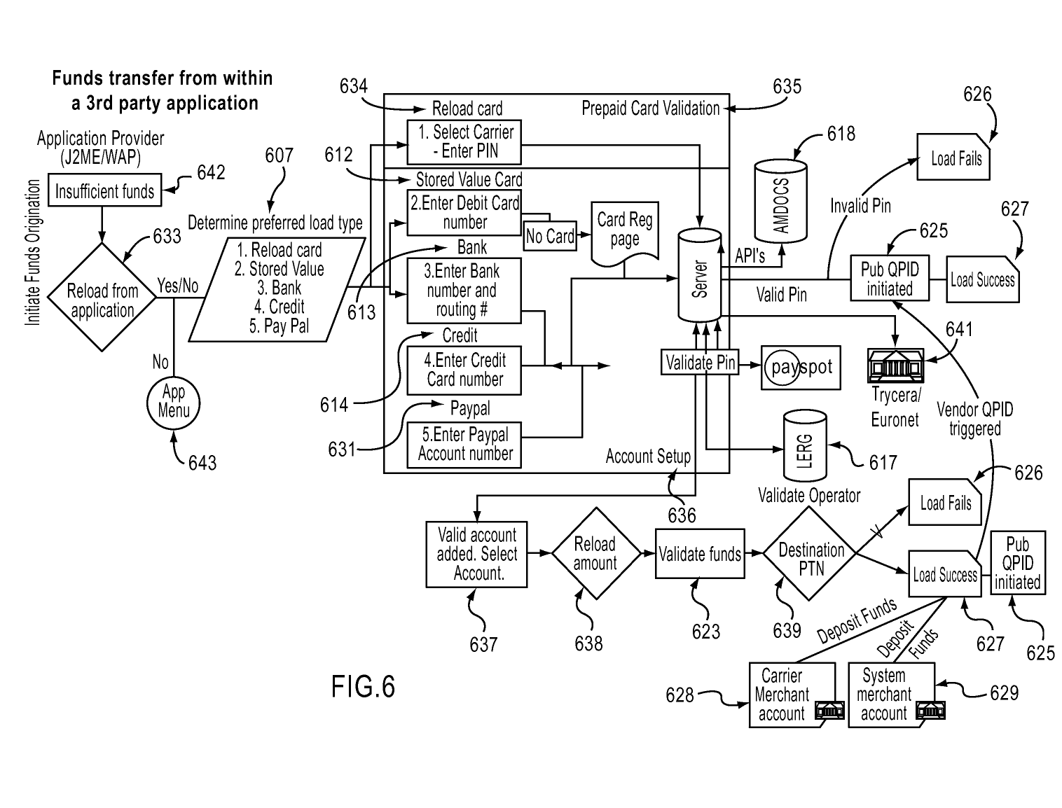

FIG. 6 is a flow chart of a reload application including a system, according to an embodiment of the invention. Once a mobile device receives input associated with insufficient funds 642, the mobile device prompts the user to reload from an application 633. If an application is not selected, the mobile device outputs an application menu 643. If an application has been selected (e.g., the mobile device has received input associated with an application selection), the mobile device prompts the user to determine a preferred load source 607, such as, for example, a reload card, a stored value account, a bank account, a credit account, a PayPal account, etc.

The mobile device can output data associated with a reload card 634, a stored value card 612, a bank interface 613, a credit interface 614 or a PayPal interface 631 based on the determined preferred load type 607. The data associated with the reload card 634 is outputted when the mobile device receives the reload card input as the determined preferred load type 607. The mobile device prompts the user to select a carrier and enter a PIN for prepaid card validation 635. The mobile device is configured to receive input associated with a carrier selection and PIN. The mobile device sends a signal associated with at least the input to the application server 620.

The mobile device outputs an interface associated with account setup 636, such as, for example, the stored value card 612, the bank interface 613, the credit interface 614 or the PayPal interface 631. The mobile device outputs the stored value card 612 to the user and prompts the user to enter a debit card number when the stored value is selected as the determine preferred load type 607. The mobile device sends a signal associated with the debit card number to the application server 620. If no card number is entered at the mobile device, the mobile device outputs a card registration page 616 to enable a user to obtain a debit card. Once the debit card is obtained, the mobile device sends a signal associated with at least the debit card number to the application server 620.

The mobile device outputs the bank interface 613 to the user and prompts the user to enter a bank number and a routing number when the bank account is selected as the determined preferred load type 607 for system account setup. The mobile device sends a signal associated with at least the bank account to the application server 620. Similarly, the mobile device outputs the credit interface 614 to the user and prompts the user to enter a credit card number. The mobile device sends a signal associated with at least the credit account to the application server 620. Similarly, the mobile device outputs the PayPal interface 631 to the user and prompts the user to enter a PayPal account number. The mobile device sends a signal associated with at least the PayPal account to the application server 620.

Once a signal is received by the application server 620, the application server 520 can validate the selected account added 637. The mobile device can prompt the user to input a reload amount 638. The application server 620 can validate the funds within the account 623 based on the reload amount 638. Once the funds are validated, the mobile device prompts the user to input a destination PTN 639. The application server 620 looks up the PTN carrier for validation in the local exchange routing guide (LERG) 617. The load can fail 626 or be successful 627. If the load is successful 627, funds are deposited into a carrier merchant account 628 or a system merchant account 629. The application server 620 also initiates a publisher QPID 625. The application server 620 can deposit funds via a billing system software, such as, for example, AMDOCS 618, etc.

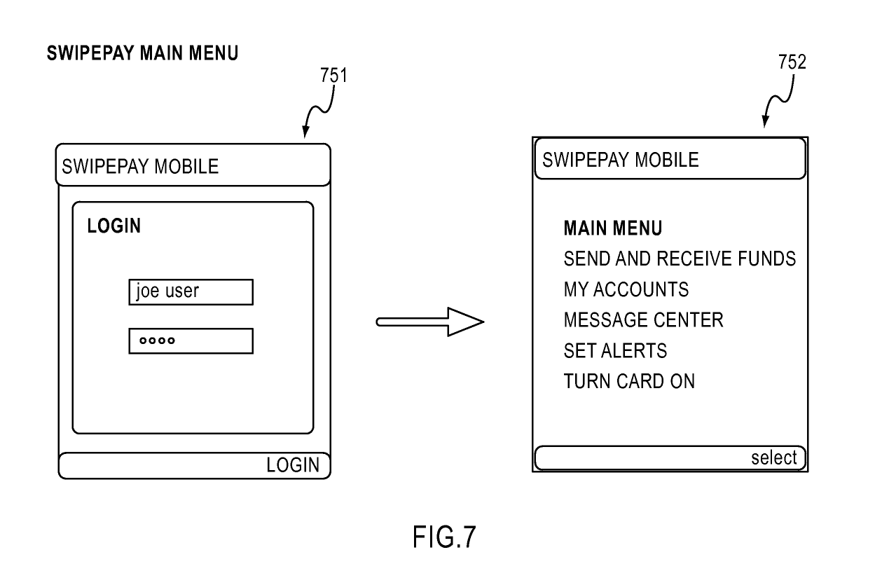

FIG. 7 shows an example of a login GUI 751 and a main menu GUI 752, according to an embodiment of the invention. The login GUI 751 includes fields to input a username and a PIN. The PIN input is masked such that only bullets are displayed in the GUI 751 to represent the characters input.

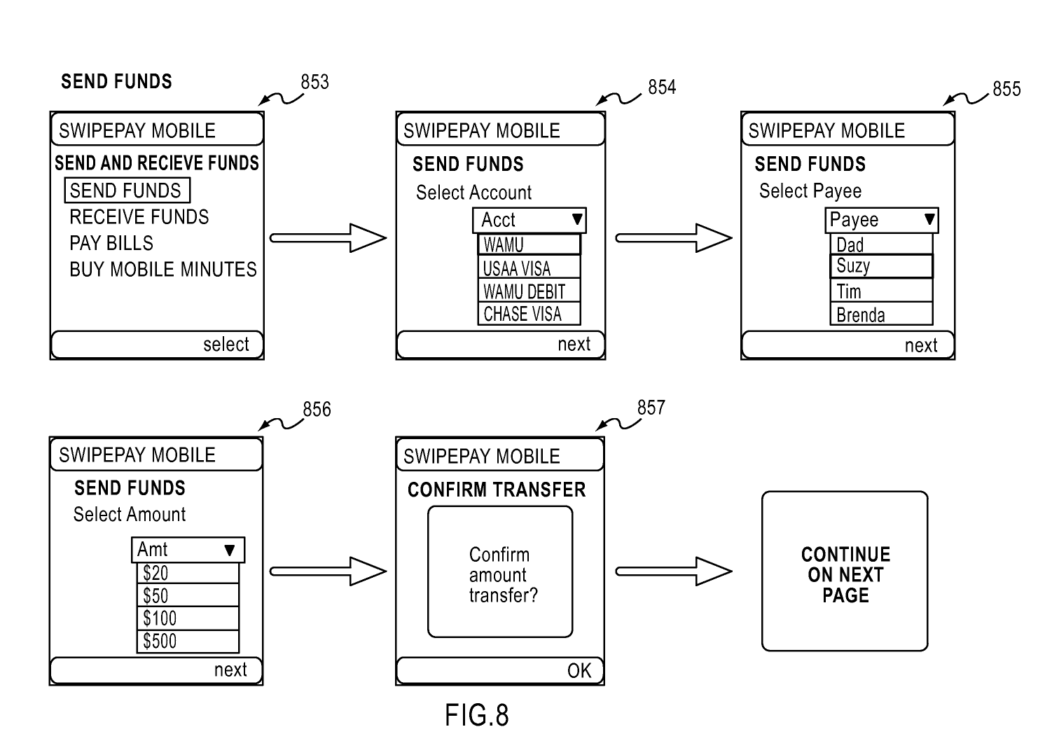

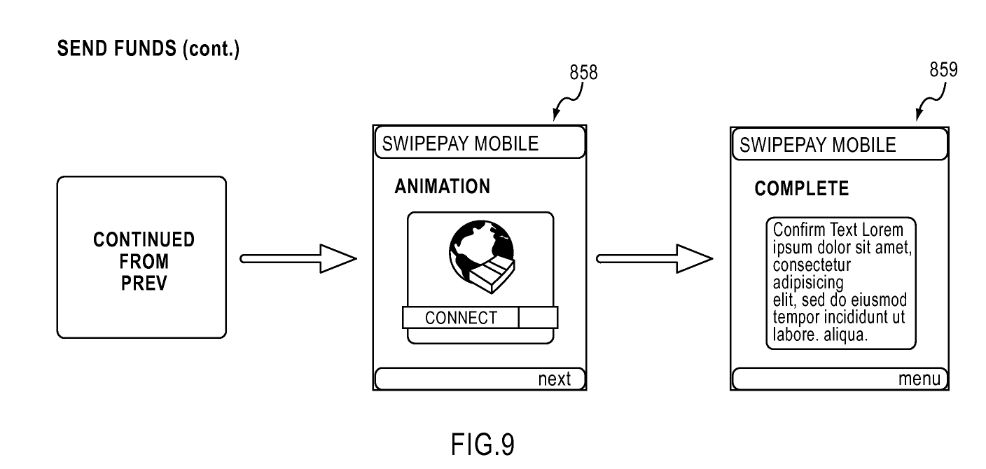

FIGS. 8 and 9 show examples of multiple GUIs associated with sending funds, according to an embodiment of the invention. A GUI 853 shows a main menu with options to send funds, receive funds, pay bills and buy mobile minutes. The mobile device outputs GUI 854 in response to receiving an input to send funds via GUI 853. GUI 854 shows multiple accounts from which to select to withdraw funds. Once an account is selected, a GUI 855 is output by the mobile device. The GUI 855 shows multiple payees previously entered by the user. After selecting a payee, the mobile device outputs a GUI 856 with options to select different amounts to send to the payee. After selecting an amount, the mobile device outputs a GUI 857 to confirm the transfer amount. Once the transfer amount is confirmed, an animation GUI 858 can be output by the mobile device while the transfer is being processed. Once the transfer of funds is complete, the mobile device can output a GUI 859 indicating that the transfer of funds has been completed.

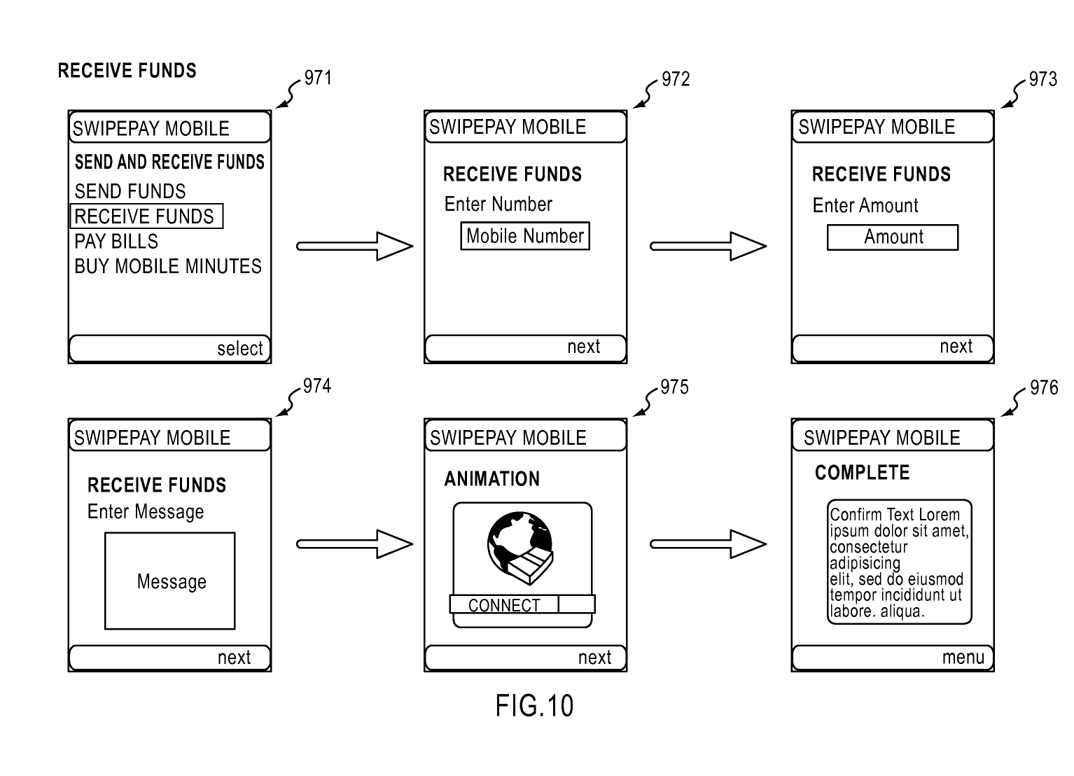

FIG. 10 shows an example of multiple GUIs associated with receiving funds, according to an embodiment of the invention. A GUI 971 shows a main menu with options to send funds, receive funds, pay bills and buy mobile minutes. The mobile device can output GUI 972, GUI 973 and GUI 974 in response to receiving an input to send funds from GUI 971. GUI 972, GUI 973, GUI 974 each include a field in which to enter a mobile number of a sender, an amount desired, and a message for the sender, respectively. Once the fields have been input, an animation GUI 975 is output by the mobile device while the information is being sent to the destination mobile number. The mobile device can output a GUI 976 indicating that the transfer information has been sent to the destination mobile number.

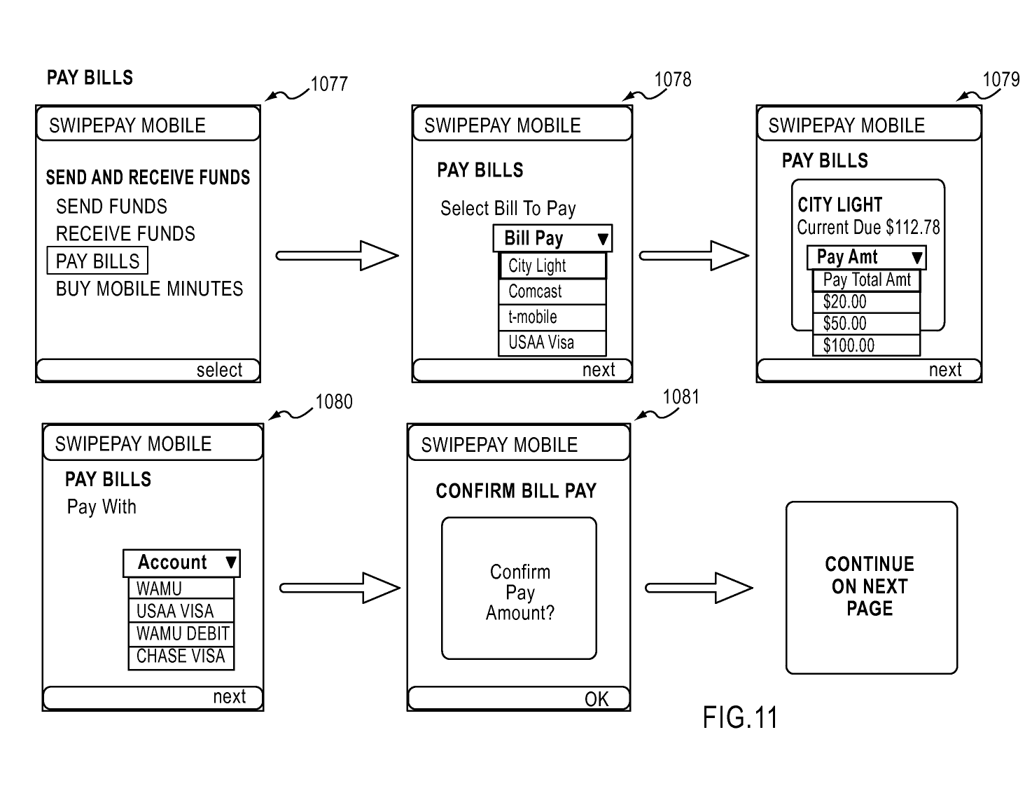

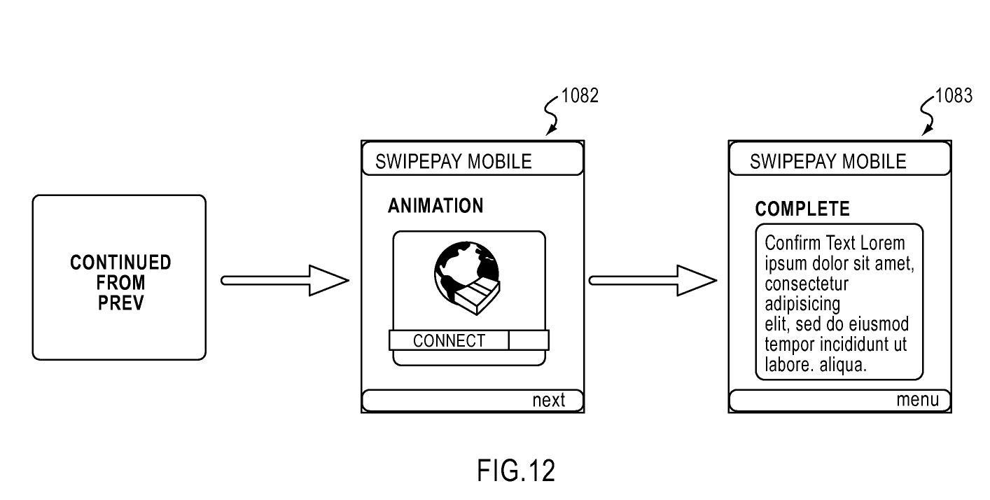

FIGS. 11 and 12 show an example of multiple GUIs associated with bill payments, according to an embodiment of the invention. A GUI 1077 shows a main menu with options to send funds, receive funds, pay bills and buy mobile minutes. The mobile device can output GUI 1078, GUI 1079 and GUI 1080 in response to receiving an input to pay bills from GUI 1077. GUI 1078, GUI 1079, GUI 1080 each include a field to select a bill, an amount to pay, and an account to pay from, respectively. The mobile device can output a GUI 1081 to confirm the payment amount. Once the fields have been input and the payment amount confirmed, an animation GUI 1082 is output by the mobile device while the payment instructions are being sent from the mobile device. The mobile device can output a GUI 1083 indicating that the transfer payment instructions have been sent.

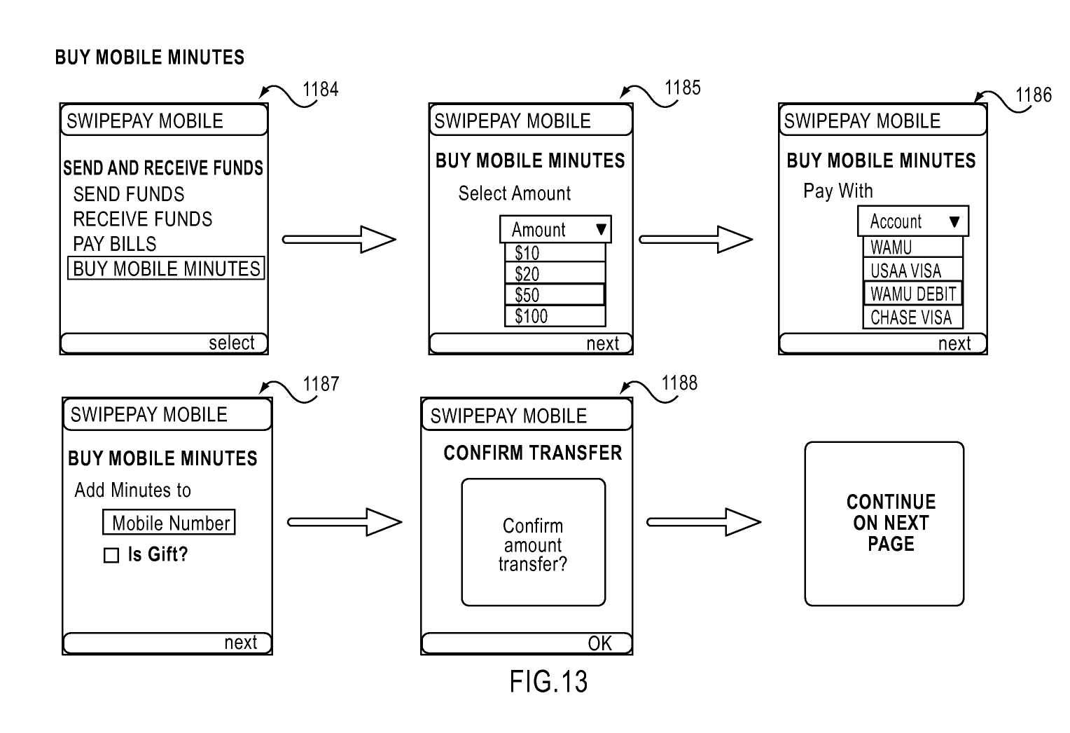

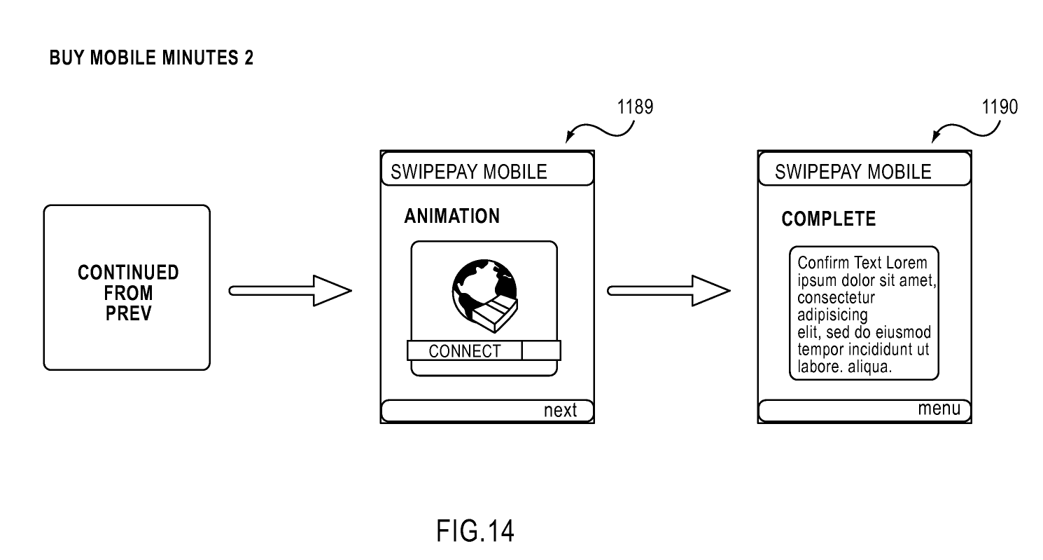

FIGS. 13 and 14 show an example of multiple GUIs associated with buying mobile minutes, according to an embodiment of the invention. A GUI 1184 shows a main menu with options to send funds, receive funds, pay bills and buy mobile minutes. The mobile device can output GUI 1185, GUI 1186 and GUI 1187 in response to receiving an input to pay bills from GUI 1184. GUI 1185, GUI 1186, GUI 1187 show a field to select an amount to buy, an account to pay from and option to add minutes to a mobile number as a gift, respectively. The mobile device can output a GUI 1188 to confirm the transfer amount. Once the fields have been input and the payment amount confirmed, an animation GUI 1189 is output by the mobile device while the transfer is being processed. The mobile device can output a GUI 1190 indicating that the transfer has been completed.

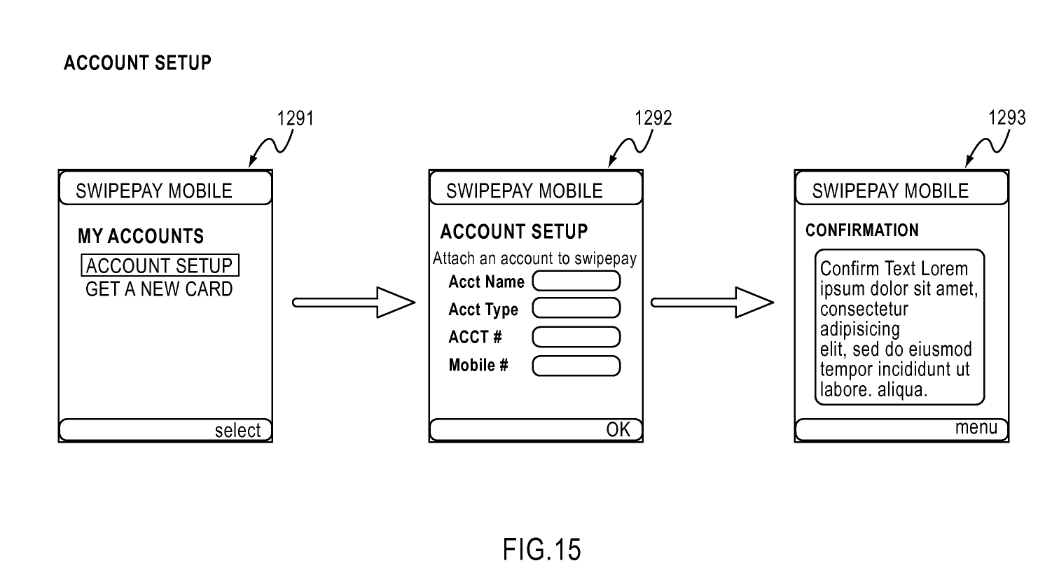

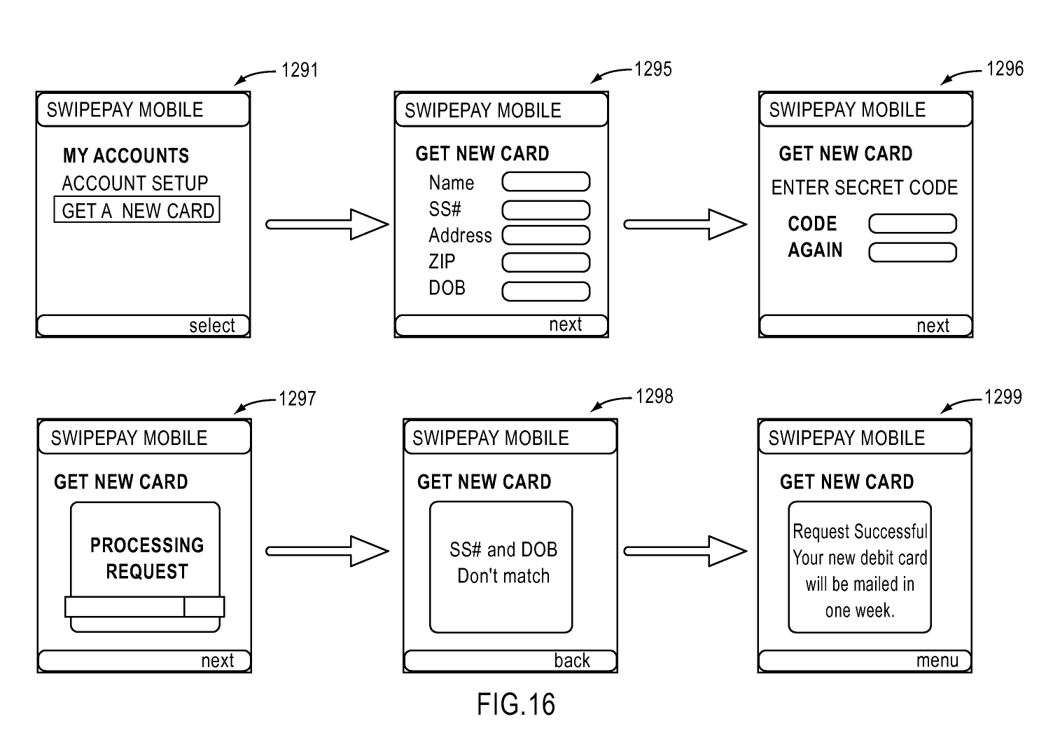

FIGS. 15 and 16 show an example of multiple GUIs associated with account setup, according to an embodiment of the invention. A GUI 1291 shows an account setup menu with options to setup account and get a new card. The mobile device can output GUI 1292 in response to receiving an input to setup account from GUI 1291. GUI 1292 shows fields to enter an account name, an account type, an account number and a mobile number. The mobile device can output a GUI 1293 to confirm the account information. The mobile device can output GUI 1295 and GUI 1296 in response to receiving an input to get a new card from GUI 1291. GUI 1295 shows fields enter basic user information, such as, for example, name, social security number, address, ZIP code and date of birth (DOB). GUI 1296 shows fields to enter a secret code to get a new card. Once the fields have been input, an animation GUI 1297 is output by the mobile device while the account information is being verified and setup. The mobile device can output a GUI 1298 when the entered social security number and DOB do not match. The mobile device can output a GUI 1299 indicating that the new card has been successfully requested.

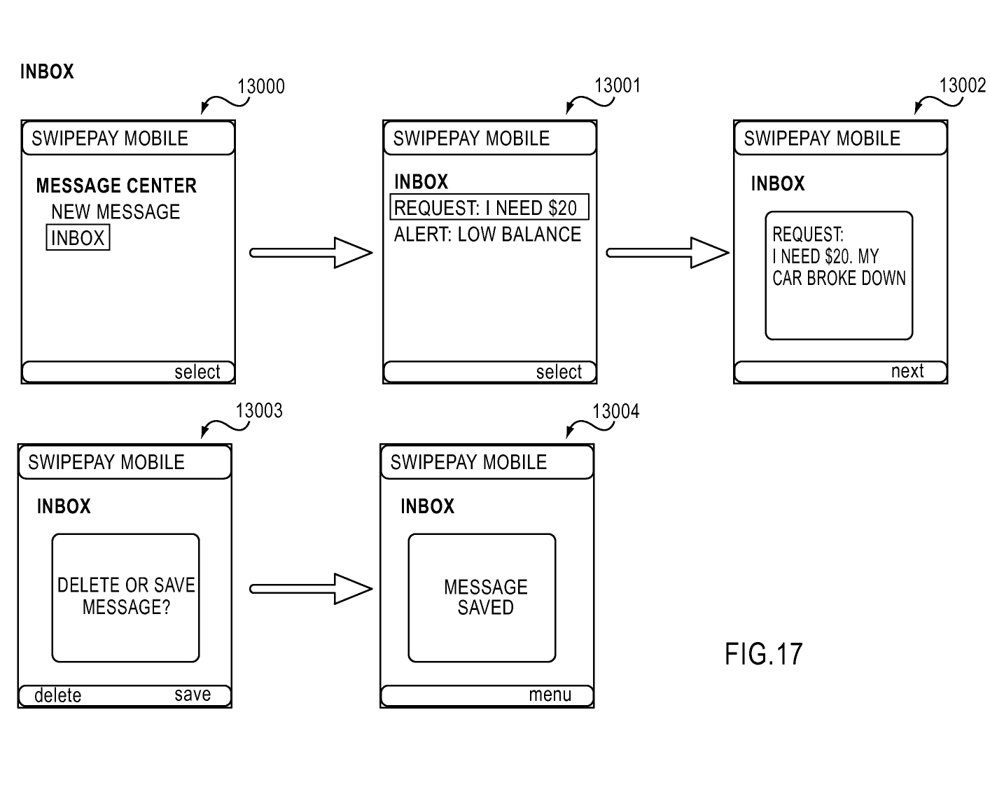

FIG. 17 shows an example of multiple GUIs associated with a system message center including an inbox, according to an embodiment of the invention. A GUI 13000 shows a message center main menu with options to create a new message and view messages stored in the inbox. The mobile device can output GUI 13001, GUI 13002 and GUI 13003 in response to receiving an input to view inbox from GUI 1300. GUI 13001 shows a portion of a request and an alert from another mobile device. GUI 13002 shows the message sent from the other mobile device. GUI 13003 shows an option to delete or save the message. The mobile device can output a GUI 13004 indicating that a message has been saved based on input received by the mobile device associated with GUI 13003.

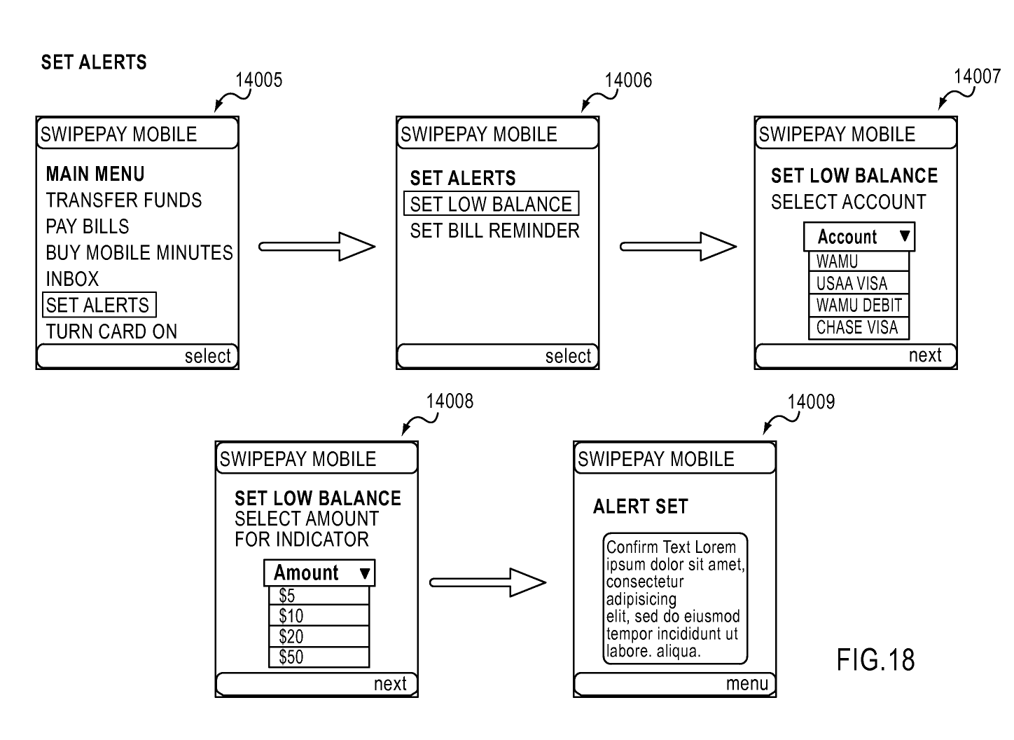

FIG. 18 shows an example of multiple GUIs associated with setting alerts, according to an embodiment of the invention. A GUI 14005 shows a main menu with options to transfer funds, pay bills, buy mobile minutes, view inbox and turn card on/off. A GUI 14006 shows a set alerts main menu output by the mobile device when the set alerts option is selected by the user at GUI 14005. The set alerts main menu includes options to set low balance and set bill reminder. The mobile device can output GUI 14007 and GUI 14008 in response to receiving an input by the user to set low balance from GUI 14006. GUI 14007 and GUI 14008 show a field to select an account to monitor and an amount for indicator, respectively. The mobile device can output a GUI 14009 indicating that the alert has been set.

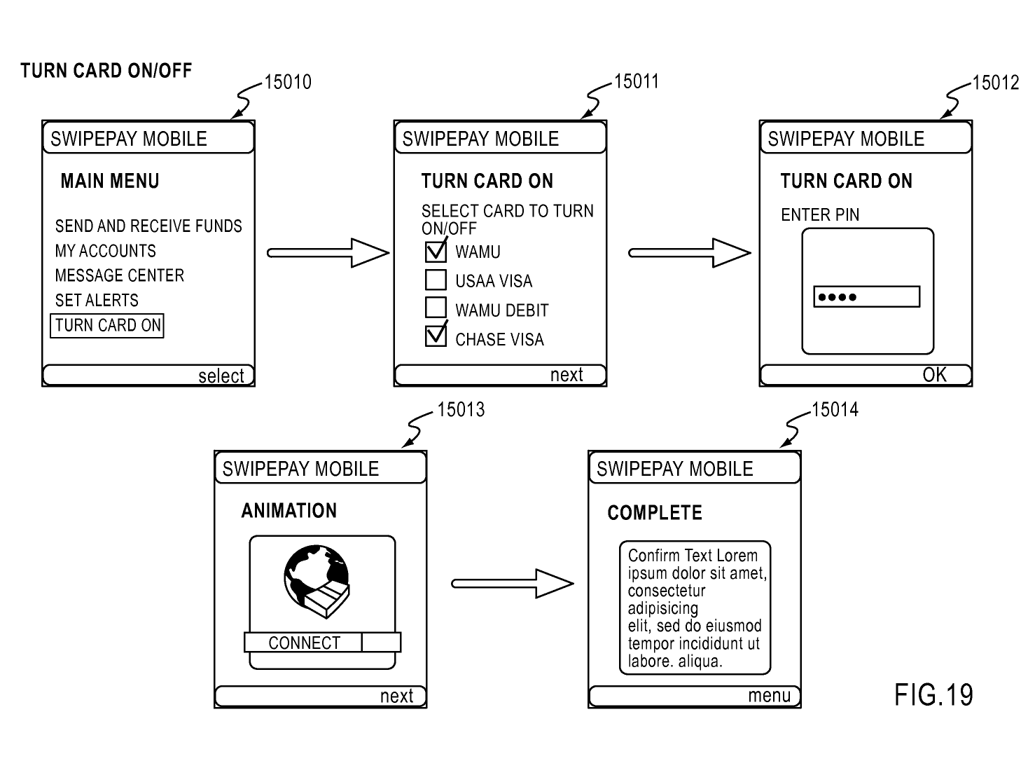

FIG. 19 shows an example of multiple GUIs associated with turning a card on and off, according to an embodiment of the invention. A GUI 15010 shows a main menu with options to send and receive funds, edit accounts, message center, set alerts and turn card on/off. The mobile device can output GUI 15011 and GUI 15012 in response to receiving an input by the user to turn card on from GUI 15010. GUI 15011 and GUI 15012 show cards to turn on and a field to enter a PIN, respectively. Once the cards have been selected and the PIN entered, an animation GUI 15013 is output by the mobile device while the instruction request is being processed. The mobile device can output a GUI 15014 indicating that the selected cards have been turned on or activated.

In some embodiments, a system can enable a user activate and deactivate accounts based on input from a mobile device. For example, the mobile device can enable the user to turn a credit card on and off via the system. The user can be prompted by the mobile device to enter an account number and pin.

In some embodiments, a user can re-up within a third party Java/WAP application with the following pre-conditions. First, the user is on a third party Java or WAP application integrated with system Billing API. Second, the user is not registered with the system. Third, the user has a bank account, credit card, stored value account or willing to sign up for a debit card. Fourth, the system has a mechanism to deposit funds into the operator's pre-paid billing system from an external source. Fifth, the system has a mechanism to charge for the application from the operator's pre-paid billing system. Sixth, the system has a mechanism to withdraw funds from some account type, such as, for example, a debit card, checking account or credit card. Seventh, the system has a mechanism to determine the mobile operator and a valid subscriber account.

The user can re-up within a third party Java/WAP application via a flow. First, a user is asked to renew their subscription for the application or otherwise buy pay to continue using the application. Second, the user clicks on purchase and has the option to reload, gift and beg if the user has a PTN). Third, the application calls the operator's billing system. Fourth, the billing system returns in-sufficient funds error. Fifth, the application links to the system WAP site passing in PTN of user if known and URL to launch the referral application. Sixth, the system presents an introduction screen with explanatory text including system options, fee, etc. Seventh, the user is asked to enter their mobile number, which can pre-populate if application passed-in the number to system WAP site, and select a PIN and user name (alias). If registered the user enters in their PTN and PIN. Eighth, the user is presented multiple options to re-up their account including member confirms account type or establishes additional account. The accounts can include, for example, an operator's pre-paid card that requires PIN activation and system integration, credit card, debit card, bank account, etc. Ninth, the user chooses bank account. The user is asked for an account number, routing number (ABA number), first name, last name, amount to draw. Tenth, the system informs the customer of the net amount that will be withdrawn from the customer's external account and the amount that will be deposited into the customer's pre-paid account. Eleventh, the system initiates money withdrawal from the account. Twelfth, withdrawal is successful with asynchronous API. Thirteenth, the system deposits money into the operator's billing system minus its fees. Fourteenth, deposit is successful. Fifteenth, the system charges the operator's billing system for the application fee. Sixteenth, the charge is successful. Seventeenth, the system WAP site launches the application so that the user can continue to use the application.

The re-up within a third party Java/WAP application has the following post conditions. First, money is withdrawn from the user's bank account. Second, money minus fees is deposited into user's pre-paid balance with operator. Third, the fee is deposited into the system's merchant account. Fourth, the user is charged the amount required by the application out of the re-upped pre-paid balance. Fifth, during settlement for the application charge the system is not paid. Subscription to the publisher service is then renewed.

In some embodiments, intra-carrier gifting is initiated through a third party Java/WAP application with the following preconditions. First, a user is on a third party Java and WAP application integrated with the system billing API. Second, the giftor or giftee may or may not be registered with the system. Third, the user has a bank account, credit card, stored value account or willing to sign up for a debit card. Fourth, the system has a mechanism to charge for the application from the operator's pre-paid billing system. Fifth, mechanism to deposit funds into the prepaid account. Sixth, the carrier billing system is setup for the system to accommodate for gifting fee.

The intra-carrier gifting is initiated through a third party Java/WAP application via a flow. First, the user is asked to renew their subscription for the application or otherwise buy credits to continue using the application. Second, the user clicks on purchase. Third, the application calls the operator's billing system. Fourth, billing system returns in-sufficient funds error. Fifth, the application presents links to the system WAP site which presents an introduction screen with explanatory text including system options to deposit funds from own account or beg for funds. Sixth, the user decides to beg for funds. Seventh, the user enters the mobile number of their friend and their own mobile number. Eighth, it is validated that the friend is a subscriber of the operator. Ninth, a gifting request message is sent to the friend. Tenth, friend receives the text message for request for money's from their friend and clicks on the link which launches a WAP site. Eleventh, the friend agrees to pay using his pre-paid balance. Twelfth, the system deducts amount plus system fees from the giftor's prepaid balance. Thirteenth, the system transfers amount into the giftee's pre-paid balance. Fourteenth, the system charges giftee for the application. Fifteenth, the operator has set up rules so that a fee from that charge goes to the system. Sixteenth, the system informs giftor that charge was successful. Seventeenth, the system notifies application provider that giftor paid. Eighteenth, the system sends a message to the giftee that they can continue to use the application. Nineteenth, the giftor re-launches the application and now can use the application.

The intra-carrier gifting initiated through a third party Java/WAP application has the following post conditions. First, money is withdrawn from the giftor's pre-paid balance. Second, money is deposited into the giftee's pre-paid balance. Third, during settlement operator pays the system.

In some embodiments, inter-carrier gifting is initiated through a third party Java/WAP application with the following preconditions. First, a user is on a third party Java and WAP application integrated with the system billing API or WAP flow. The WAP does not require API integration, only Java applications from the third party application publisher. Second, both carriers are integrated with the system. Third, the system a mechanism to charge for the application from the operator's pre-paid billing system. Fourth, the system has a mechanism to withdraw funds from some account type. The account can be, for example, a debit card, checking account, prepaid account or credit card. Fifth, the user has a debit card, checking account, bank account, or has the propensity to sign up for a debit card if the previous conditions do not exist.

Inter-carrier gifting is initiated through a third party Java/WAP application via a flow. First, the user is asked to renew their subscription for the application or otherwise buy credits to continue using the application. Second, the user clicks on purchase. Third, the application calls the operator's billing system. Fourth, the billing system returns in-sufficient funds error. Fifth, the application link to the system WAP site which presents a system introduction screen with explanatory text including system options to deposit funds from own account or beg for funds. Sixth, the user decides to beg for funds from a friend on another carrier. Seventh, the user enters the mobile number of their friend, selects the other carrier from a list and their own mobile number. Eighth, it is validated that the friend is a subscriber of the operator. Ninth, a gifting request message is send to the friend. Tenth, the friend receives the text message for request for money's from their friend and clicks on the link which launches a WAP site. Eleventh, the friend is presented multiple options to pay, such as, for example, credit card, debit card, bank account, enter carrier and PIN activation code (if prepaid card is purchased), etc. Twelfth, the friend selects the credit card or is presented with a Debit Card registration page if the previous conditions do not apply. Thirteenth, the friend is asked to enter credit card details, such as, for example, card type, card number, expiration, billing ZIP, security code, etc. if the user wants to add a credit card to the system account. The friend is also asked to enter registration details, such as, for example, PIN and PTN. Fourteenth, the system informs the customer of the net amount that will be withdrawn from the customer's external account. Fifteenth, the system charges the giftor's card for the amount. Sixteenth, the charge is successful. Seventeenth, the system deposits the amount minus fees into the Originating Operator's pre-paid balance for giftee. Eighteenth, the system charges the amount minus fee for the application on the Originating Operator. Additionally, the system charges a fee in addition to the reload or gift amount. Nineteenth, the system informs giftor that charge was successful. Twentieth, the system notifies the application provider that giftor paid. Twenty-first, the system sends a message to the giftee that they can continue to use the application. Twenty-second, the giftor re-launches the application and now can use the application. Twenty-third the system settles transfers funds periodically to destination carrier via ACH. Twenty-fourth, the originating carrier of the gift gets a portion of the gifting fee. The system can periodically do an ACH transfer to the originating carrier.

Inter-carrier gifting initiated through a third party Java/WAP application has the following post conditions. First, money is withdrawn from the giftor's credit card. Second, money is deposited into the system account. Third, money is deposited into the giftee's pre-paid balance. Fourth, a charge is placed against the giftee for the use of the application. Fifth, during settlement for the application charge the system is not paid.

In some embodiments, funds can be transferred from within a system Java application with the following preconditions. First, the system Java application is available on a CDMA, GSM or iDen handset. Second, a sender is registered with the system and has setup accounts to withdraw funds. Third, the system has a mechanism to deposit funds into the operator's pre-paid billing system from an external source. Fourth, the system has a mechanism to transfer funds from a prepaid account bank account, debit card, credit card or PayPal account both domestically and internationally. Fifth, a mechanism to determine the mobile operator and a valid subscriber account. Sixth, the system has a mechanism to track payments, revenue share for each operator and settle debt obligations each month. Seventh, a receiver has registered with the system.

In an alternative embodiment, funds can be transferred from within a system Java application via a flow. First, a user enters their PTN and PIN code to access main menu. Second, the user would like to transfer funds to another system user. Third, the user clicks on send funds and enters destination PTN. The user also has the option to reload their prepaid account, gift funds to another prepaid account user which is deposited into the users prepaid account directly and beg for funds. Fourth, the user enters the amount of funds to be transferred and, optionally, a destination carrier. User may enter debit card number, system alias, or PTN. Fifth, the user is asked to determine the account type for the source of funds. The user also has the option to add another account type. Sixth, the system confirms payment amount with the cost of the transfer in the total. User confirms the transfer and agree. Seventh, the user receives a message the funds either have been successfully transferred or if an error occurred such as insufficient funds, destination account invalid, etc. Eighth, the system deposits money into the destination account. All funds are deposited into the receivers system account unless the funds have been sent either directly to a prepaid billing system or directly to a debit card. The user can transfer the funds in order to place funds into their bank accounts or if they want to reload their own prepaid account. Ninth, the system places transfer fees directly into company merchant account. Tenth, a text message and a message to the Java application is sent to the receiver. Eleventh, a transaction history is updated for the sender and receiver.

Funds transfer from within a system Java application have the following post conditions. First, money is withdrawn from the user's bank account. Second, money minus fees is deposited into receivers system account, debit card or prepaid account. Third, a fee is deposited into system's merchant account. Fourth, the user is charged the appropriate transfer fee (e.g., domestic or international fee). Fees can vary depending on whether a debit card was used. Fifth, revenue share to the operator where the funds transfer originated is tracked and paid out at the end of the month.

### CONCLUSION

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents. While the invention has been particularly shown and described with reference to specific embodiments thereof, it will be understood that various changes in form and details may be made.

What is claimed is:

1. A processor-readable medium storing code representing instructions to cause a processor to perform a process, the code comprising code to:
receive from a first mobile device associated with a first network a minute transfer request, the minute transfer request operative to transfer data associated with an allowable use time of the first mobile device from an account associated with the first mobile device associated with the first network to an account associated with a second mobile device associated with a second network different than the first network; and
send from the first network to the account associated with the second mobile device associated with the second network the data associated with the allowable use time based on the minute transfer request,
the data associated with the allowable use time representing at least a portion of the allowable use time of the first mobile device.

2. The processor-readable medium of claim 1, the code further comprising code to:
receive from the account associated with the first mobile device the data associated with the allowable use time based on the minute transfer request before the data associated with the allowable use time is sent.

3. The processor-readable medium of claim 1, wherein the minute transfer request is a first minute transfer request and the allowable use time is a first allowable use time, the code further comprising code to:
receive from the first mobile device associated with the first network a second minute transfer request, the second minute transfer request operative to transfer data associated with a second allowable use time of the first mobile device from the account associated with the first mobile device associated with the first network to an account associated with a third mobile device associated with a third network different than the first network; and
send from the first network to the account associated with the third mobile device associated with the third network the data associated with the second allowable use time based on the second minute transfer request,
the data associated with the second allowable use time representing at least a portion of the allowable use time of the first mobile device.

4. The processor-readable medium of claim 1, wherein the minute transfer request includes financial data operative to transfer funds from a financial account associated with a user of the first mobile device to a financial account associated with a user of the second mobile device.

5. The processor-readable medium of claim 1, the code further comprising code to:
determine whether a user of the first mobile device is authentic before the data associated with the allowable use time is sent.

6. The processor-readable medium of claim 1, wherein the data associated with the allowable use time represents at least a portion of allowable use time associated with a prepaid account associated with the first mobile device.

7. The processor-readable medium of claim 1, wherein the first network is defined based on a first protocol, the second network is defined based on a second protocol different than the first protocol.

8. The processor-readable medium of claim 1, wherein the first network is a provider network.

9. A processor-readable medium storing code representing instructions to cause a processor to perform a process, the code comprising code to:
receive from a mobile device associated with a first network a financial transfer request configured to transfer funds from an account associated with a user of the mobile device associated with a first financial institution to an account associated with a receiving party at a second financial institution, the receiving party being associated with a second network different than the first network; and
send data associated with the funds from the first network to the second network to the account of the receiving party based on the financial transfer request.

10. The processor-readable medium of claim 9, the code further comprising code to:
send to the financial institution of the user a request for the funds before the data associate with the funds is sent;
receive from the financial institution the funds; and
store the funds at a system account of the user of the mobile device at least until the funds are verified based on the financial transfer request.

11. The processor-readable medium of claim 9, the code further comprising code to:
receive from the first mobile device an account activation request operative to activate the account associated with the user of the mobile device associated with the first financial institution before data associated with the funds is sent.

12. The processor-readable medium of claim 9, the code further comprising code to:
receive from the first mobile device an account deactivation request operative to deactivate the account associated with the user of the mobile device associated with the first financial institution after data associated with the funds is sent.

13. The processor-readable medium of claim 9, wherein the mobile device is a first mobile device associated with a first network, the user is a first user and the receiving party is a second user of a second mobile device associated with the second network.

14. The processor-readable medium of claim 9, wherein the account associated with the user of the mobile device is one of a prepaid account, a bank account, credit card account or a debit card account.

15. The processor-readable medium of claim 9, wherein the account associated with the receiving party is one of a prepaid account, a bank account, credit card account or a debit card account.

16. The processor-readable medium of claim 9, wherein the first network is defined based on a first protocol, the second network being defined based on a second protocol different than the first protocol.

17. The processor-readable medium of claim 9, wherein the first financial institution is different from the second financial institution.

18. A processor-readable medium storing code representing instructions to cause a processor to perform a process, the code comprising code to:
receive from a first mobile device associated with a first network an account activation request and a financial transfer request; and
transfer funds from an account at a financial institution associated with the account activation request to an account of a second mobile device associated with a second network different than the first network based on the financial transfer request when the account associated with the account activation request at the financial institution is activated based on the account activation request.

19. The processor-readable medium of claim 18, the code further comprising code to:
receive from the first mobile device associated with the first network a deactivation request; and
send to the financial institution a signal based on the deactivation request such that the account associated with the account activation request is deactivated.

20. The processor-readable medium of claim 18, the code further comprising code to:
send, before the funds are transferred, a request for the funds to the financial institution associated with the account activation request;
receive from the financial institution associated with the account activation request the funds; and
store the funds at least until funds are verified based on the financial transfer request.

21. The processor-readable medium of claim 18, wherein the account at the financial institution associated with the account activation request is one of a prepaid account, a bank account, a credit card account or a debit card account.

22. The processor-readable medium of claim 18, wherein the account of the second mobile device associated with the second network is one of a prepaid account, a bank account, a credit card account or a debit card account.

23. A processor-readable medium storing code representing instruction to cause a processor to perform a process, the code comprising code to:
send from a first mobile device associated with a first network a minute transfer request such that data associated with an allowable use time based on the minute transfer request is sent from an account associated with the first mobile device associated with the first network to an account associated with a second mobile device associated with a second network different than the first network; and
receive a confirmation after the data associated with the allowable use time is received at the account associated with the second mobile device.

24. The processor-readable medium of claim 23, wherein the data associated with the allowable use time represents at least a portion of the allowable use time of the first mobile device.

25. The processor-readable medium of claim 23, the code further comprising code to:
authenticate a user of the first mobile device before the minute transfer request is sent.

26. The processor-readable medium of claim 23, the code further comprising code to:
receive a selection of the allowable use time before the minute transfer request is sent, the data associated with the allowable user time being based on the selection.

27. The processor-readable medium of claim 23, the code further comprising code to:
send from the first mobile device associated with the first network a financial transfer request such that data associated with funds based on the financial transfer request is sent from an account associated with a user of the first mobile device associated with a first financial institution to an account associated with a receiving party at a second financial institution, the receiving party being associated with a second network different than the first network.

28. A processor-readable medium storing code representing instruction to cause a processor to perform a process, the code comprising code to:
send from a mobile device associated with a first network a financial transfer request such that data associated with funds based on the financial transfer request is sent from an account associated with a user of the mobile device associated with a first financial institution to an account associated with a receiving party at a second financial institution, the receiving party being associated with a second network different than the first network; and
receive a confirmation after the data associated with the funds is received at the account associated with the receiving party at the second financial institution.

29. The processor-readable medium of claim 28, the code further comprising code to:
authenticate the user of the mobile device before the financial transfer request is sent.

30. The processor-readable medium of claim 28, the code further comprising code to:
receive a selection from the user of the mobile device representative of the account associated with the user of the mobile device, the account associated with the user of the mobile device being one of a prepaid account, a bank account, a credit card account or a debit card account.

31. The processor-readable medium of claim 28, the code further comprising code to:
receive a selection from the user of the mobile device representative of a monetary value associated with the funds.

32. The processor-readable medium of claim 28, the code further comprising code to:
send from the mobile device associated with the first network a minute transfer request such that data associated with an allowable use time based on the minute transfer request is sent from an account associated with the mobile device associated with the first network to an account associated with a second mobile device associated with a second network different than the first network, the receiving party being a user of the second mobile device.
